(19) United States
(12) Patent Application Publication
(10) Pub. No.: US 2026/0065160 A1
(43) Pub. Date: Mar. 5, 2026

(54) INFORMATION PROCESSING SYSTEM, INFORMATION PROCESSING DEVICE, INFORMATION PROCESSING METHOD, SCHEDULING METHOD, INFORMATION PROCESSING PROGRAM, AND SCHEDULING PROGRAM

(71) Applicant: Preferred Networks, Inc., Tokyo (JP)

(72) Inventors: Hiroaki MIKAMI, Tokyo (JP); Gentaro WATANABE, Tokyo (JP)

(21) Appl. No.: 19/312,980

(22) Filed: Aug. 28, 2025

(30) Foreign Application Priority Data
Aug. 30, 2024 (JP) 2024-148229

(51) Int. Cl. G06N 20/00; G06F 9/50

(52) U.S. Cl. CPC G06N 20/00; G06F 9/5027

(57) ABSTRACT

An information processing system includes a plurality of memories and a plurality of processors configured to perform parallel processing using a model. The plurality of processors execute communication processing of a result of executing computational processing using at least a part of the model for first input data, and computational processing using at least a part of the model for second input data, such that processing periods of the communication processing and the computational processing at least partially overlap.

### CROSS-REFERENCE TO RELATED APPLICATIONS

This patent application is based on and claims priority to Japanese Patent Application No. 2024-148229 filed on Aug. 30, 2024, the entire contents of which are incorporated herein by reference.

### TECHNICAL FIELD

The present disclosure relates to an information processing system, an information processing device, an information processing method, a scheduling method, an information processing program, and a scheduling program.

### BACKGROUND

As a method for improving the training speed when training a large-scale model using a large amount of data, a method using intra-layer parallelism such as tensor parallelism is known. In order to further improve the execution speed, scheduling that enables further parallelization is required.

### RELATED ART DOCUMENT

### Non-Patent Document

[Non-Patent Documents 1] Mohammad Shoeybi, Mostofa Patwary, Raul Puri, Patrick LeGresley, Jared Casper, Bryan Catanzaro “Megatron-LM: Training Multi-Billion Parameter Language Models Using Model Parallelism,” arXiv: 1909.08053v4 [cs. CL], 13 Mar. 2020, [Date of search 2024.4.5]

### Summary

According to one aspect of the present disclosure, an information processing system includes a plurality of memories and a plurality of processors configured to perform parallel processing using a model. The plurality of processors execute communication processing of a result of executing computational processing using at least a part of the model for first input data, and computational processing using at least a part of the model for second input data, such that processing periods of the communication processing and the computational processing at least partially overlap.

### BRIEF DESCRIPTION OF THE DRAWINGS

FIG. 1 is a diagram illustrating an example of a system configuration of an information processing system;

FIG. 2 is a diagram illustrating an example of a hardware configuration of the information processing device;

FIG. 3 is a diagram illustrating an example of a functional configuration of the information processing device;

FIG. 4 is a diagram illustrating an outline of scheduling by an information processing device according to a first embodiment;

FIG. 5 is a first diagram illustrating a specific example of scheduling by a scheduling unit of a comparative example;

FIG. 6 is a first diagram illustrating a specific example of scheduling by a scheduling unit of the information processing device according to the first embodiment;

FIG. 7A is a second diagram illustrating a specific example of the scheduling by the scheduling unit of the information processing device according to the first embodiment;

FIG. 7B is a third diagram illustrating a specific example of the scheduling by the scheduling unit of the information processing device according to the first embodiment;

FIG. 7C is a fourth diagram illustrating a specific example of the scheduling by the scheduling unit of the information processing device according to the first embodiment;

FIG. 8 is a diagram illustrating an outline of scheduling by an information processing device according to a second embodiment;

FIG. 9A is a first diagram illustrating a specific example of scheduling by a scheduling unit of the information processing device according to the second embodiment;

FIG. 9B is a second diagram illustrating a specific example of the scheduling by the scheduling unit of the information processing device according to the second embodiment;

FIG. 10 is a diagram illustrating an outline of scheduling by an information processing device according to a third embodiment;

FIG. 11 is a second diagram illustrating a specific example of the scheduling by the scheduling unit of the comparative example;

FIG. 12A is a first diagram illustrating a specific example of scheduling by a scheduling unit of the information processing device according to the third embodiment;

FIG. 12B is a second diagram illustrating the specific example of the scheduling by the scheduling unit of the information processing device according to the third embodiment;

FIG. 13 is a diagram illustrating an outline of scheduling by an information processing device according to a fourth embodiment;

FIG. 14A is a first diagram illustrating a specific example of scheduling by a scheduling unit of the information processing device according to the fourth embodiment;

FIG. 14B is a second diagram illustrating the specific example of the scheduling by the scheduling unit of the information processing device according to the fourth embodiment;

FIG. 15 is a diagram illustrating an outline of scheduling by an information processing device according to a sixth embodiment; and

FIG. 16 is a diagram illustrating a specific example of scheduling by a scheduling unit of an information processing device according to a seventh embodiment.

### DETAILED DESCRIPTION

Embodiments will be described below with reference to the attached drawings. Here, in the present specification and the drawings, components having substantially the same functional configuration will be denoted by the same reference numerals, and duplicate descriptions will be omitted.

### First Embodiment

### <System Configuration of Information Processing System>

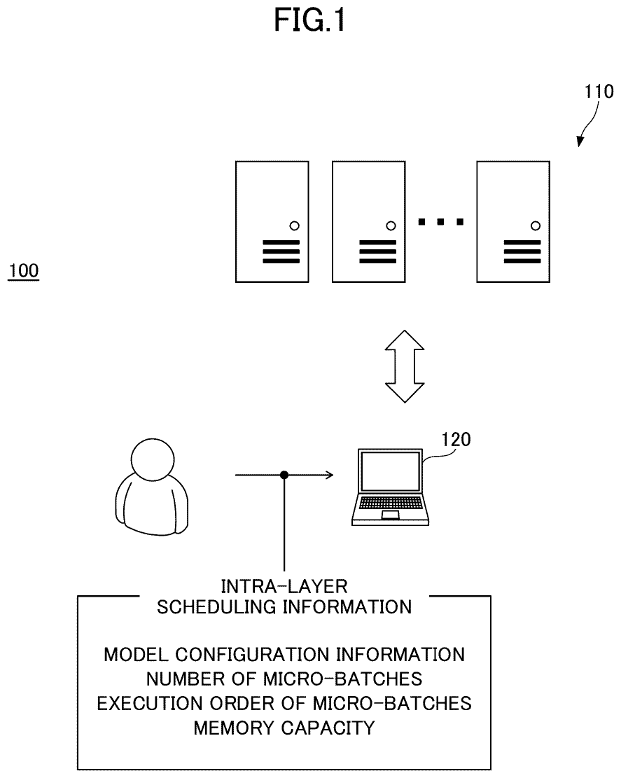

First, a system configuration of an information processing system according to a first embodiment will be described. FIG. 1 is a diagram illustrating an example of the system configuration of the information processing system. As illustrated in FIG. 1, an information processing system 100 according to the first embodiment includes a plurality of server devices (a server device group 110) and an information processing device 120.

The server device group 110 performs a training process for a model to be trained. The model to be trained is, for example, a neural network. However, it is not limited to the neural network, and a model other than the neural network may be used. The training process by the server device group 110 is performed based on a schedule generated by the information processing device 120 (a schedule of a training process using intra-layer parallelism).

The information processing device 120 generates a schedule for causing each worker to efficiently perform the training process using intra-layer parallelism for the model to be trained. Here, in the present embodiment, the worker refers to a plurality of server devices included in the server device group 110. That is, one worker includes a plurality of server devices.

However, the definition of the worker is not limited thereto, and the worker may refer to one or more server devices included in the server device group 110. Additionally, one worker may be one or more server devices, or one worker may be one or more information processing devices. Using a more general expression, one worker may refer to one device or a group including a plurality of devices specified as a schedule assignment destination.

Alternatively, the worker may refer to a plurality of accelerators included in one server device. That is, one worker may include a plurality of accelerators. Alternatively, the worker may refer to one accelerator included in one server. That is, one worker may be one accelerator. Here, an accelerator is used as an example, but an accelerator may be read as a graphics processing unit (GPU). Alternatively, an accelerator may be read as a processor. Using a more general expression, one worker may be one component or a group including a plurality of components specified as a schedule assignment destination.

Here, in the present embodiment, the processing to be executed by the worker for each micro-batch of training data during the training process includes forward calculation and backward calculation.

That is, in the present embodiment, the information processing device 120 is configured to:
accept information for intra-layer scheduling as input; and
g generate a schedule for forward calculation and backward calculation.

Here, the information processing device 120 accepts, as the information for the intra-layer scheduling, for example,
configuration information indicating a configuration of the model to be trained,
the number of micro-batches of training data to be used for the training process,
the execution order of the micro-batches when the training process is performed,
the memory capacity of each worker to be used for the training process, and the like.

The information processing device 120 transmits the generated schedule to the server device group 110. With this, the server device group 110 stores an information processing program for performing the training process based on the schedule generated by the information processing device 120. As a result, each worker in the server device group 110 can perform the training process based on the generated schedule.

Here, as an example of the training process to be performed by each worker in the server device group 110, for example, when the model to be trained is a neural network (NN), it is conceivable that each worker performs a training process for a corresponding layer, as described below:
Worker name=Worker0: the first layer of NN, and
Worker name=Worker1: the second layer of NN. Alternatively, it is a conceivable that each worker performs a training process for a plurality of corresponding layers, as described below:
Worker name=Worker0: the first to Nth layer of NN, and
Worker name=Worker1: N+1th to 2Nth layer of NN. That is, it is conceivable that the NN is divided as evenly as possible and each worker handles a training process in order from a layer closest to the input.

However, when the number of layers of NN is not divisible by the number of workers, the number of layers that some workers are responsible for when performing the training process may be less than the number of layers that the other workers are responsible for when performing the training process. Alternatively, when a special calculation is included in a layer around the input and a layer around the output, there may be a case where the calculation load is unbalanced between the workers.

### <Hardware Configurations of Server Device and Information Processing Device>

Next, a hardware configurations of the server device included in the server device group 110 and a hardware configuration of the information processing device 120 will be described. Here, the server device included in the server device group 110 and the information processing device 120 have substantially the same hardware configuration, and thus the hardware configuration of the information processing device 120 will be described here.

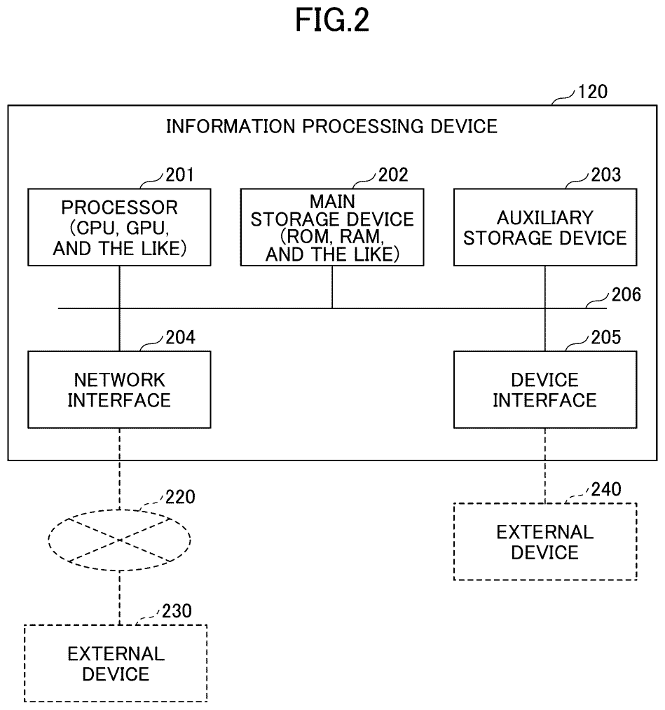

FIG. 2 is a diagram illustrating an example of the hardware configuration of the information processing device. The information processing device 120 includes, as components, a processor 201, a main storage device 202 (memory), an auxiliary storage device 203 (memory), a network interface 204, and a device interface 205. The information processing device 120 may be realized as a computer in which these components are connected via a bus 206. Here, in the example of FIG. 2, the information processing device 120 is illustrated as including one component each, but the information processing device 120 may include multiple pieces of the same component.

Various operations of the information processing device 120 may be executed in parallel using one or more processors. Additionally, various operations may be distributed to a plurality of operation cores in the processor 201 and executed in parallel. Additionally, part or all of the processing, means, and the like of the present disclosure may be executed by an external device 230 (at least one of a processor or a storage device) provided on a cloud that can communicate with the information processing device 120 via the network interface 204.

The processor 201 may be an electronic circuit (a processing circuit, processing circuitry, a CPU, a GPU, an FPGA, an ASIC, or the like). Additionally, the processor 201 may be a semiconductor device or the like including a dedicated processing circuit. Here, the processor 201 is not limited to an electronic circuit using an electronic logic element, but may be realized by an optical circuit using an optical logic element. Additionally, the processor 201 may include an arithmetic function based on quantum computing.

The processor 201 executes various operations based on various data and commands input from a device or the like of the internal components of the information processing device 120, and outputs operation results and control signals to a device or the like. The processor 201 controls each component of the information processing device 120 by executing an operating system (OS), applications, and the like.

Additionally, the processor 201 may refer to one or more electronic circuits arranged on one chip, or one or more electronic circuits arranged on two or more chips or devices. When a plurality of electronic circuits are used, the electronic circuits may communicate with each other by wired connection or wirelessly.

The main storage device 202 is a storage device that stores instructions executed by the processor 201, various data, and the like, and the various data stored in the main storage device 202 are read out by the processor 201. The auxiliary storage device 203 is a storage device other than the main storage device 202. Here, these storage devices are referred to as any electronic component that can store various data, and may be semiconductor memories. The semiconductor memory may be either a volatile memory or a non-volatile memory. The storage device for storing various data in the information processing device 120 may be realized by the main storage device 202 or the auxiliary storage device 203, or may be realized by a built-in memory built in the processor 201.

Additionally, a plurality of processors 201 may be connected (coupled) to one main storage device 202, or a single processor 201 may be connected. Alternatively, a plurality of main storage devices 202 may be connected (coupled) to one processor 201. When the information processing device 120 includes at least one main storage device 202 and a plurality of processors 201 connected (coupled) to the at least one main storage device 202, a configuration in which at least one processor among the plurality of processors 201 is connected (coupled) to the at least one main storage device 202 may be included.

The network interface 204 is an interface for connecting to a communication network 220 by wired connection or wirelessly.

The device interface 205 is an interface such as a USB directly connected to an external device 240.

As an example, the external device 240 may be an input device. In the present embodiment, the input device may be, for example, an electronic device such as a camera, a microphone, various sensors, a keyboard, a mouse, a touch panel, or the like, and provides the acquired information to the information processing device 120.

Additionally, the external device 240 may be, for example, an output device. In the present embodiment, the output device may be, for example, a display device such as a liquid crystal display (LCD), a cathode ray tube (CRT), a plasma display panel (PDP), an organic electro luminescence (EL) panel, or the like, or a speaker for outputting sound or the like.

Additionally, the external device 240 may be a storage device (memory). For example, the external device 240 may be a network storage device, and the external device 240 may be a storage device such as an HDD.

Additionally, the external device 240 may be a device having a function of part of the components of the information processing device 120. That is, the information processing device 120 may send and receive processing results to and from the external device 240.

### <Functional Configuration of Information Processing Device>

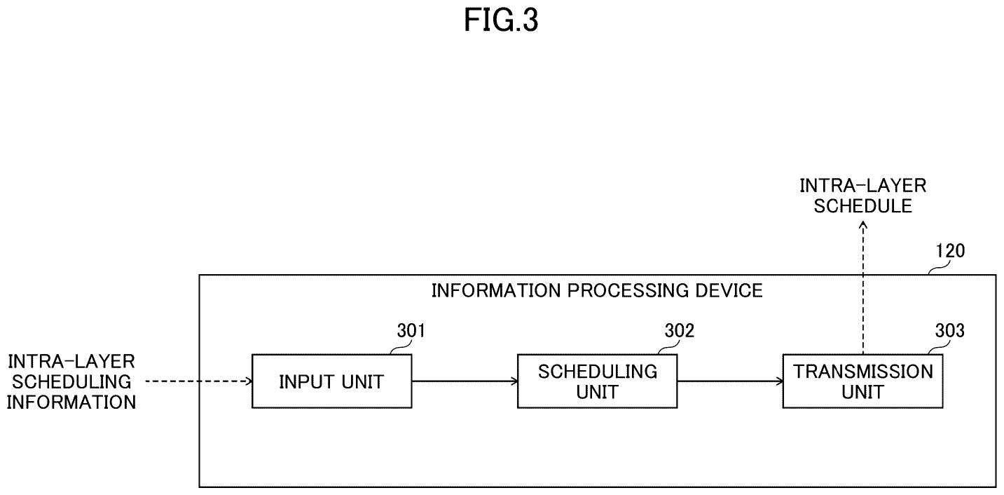

Next, a functional configuration of the information processing device 120 will be described. FIG. 3 is a diagram illustrating an example of the functional configuration of the information processing device. A scheduling program is installed in the information processing device 120, and by executing the program, the information processing device 120 functions as an input unit 301, a scheduling unit 302, and a transmission unit 303.

The input unit 301 accepts information for intra-layer scheduling as input. The details of the information for intra-layer scheduling that the input unit 301 accepts as input have already been described with reference to FIG. 1, the description thereof is omitted here. The input unit 301 notifies the scheduling unit 302 of the information for intra-layer scheduling that has been accepted as input.

The scheduling unit 302 schedules the execution procedure of forward calculation and backward calculation based on the information for intra-layer scheduling provided from the input unit 301 as the notification. At this time, the scheduling unit 302 schedules the forward calculation and backward calculation to be executed in intra-layer parallelism (tensor parallelism in the first embodiment). Here, tensor parallelism is distributed parallel processing of matrix products in layers. Additionally, when scheduling, the scheduling unit 302 performs scheduling by using, as a group, a plurality of sets of input data that are input to respective accelerators of the worker. Specifically, in accelerators, the scheduling unit 302 schedules the following processing to be executed in parallel:
communication processing between the accelerators after computational processing of the first input data in an accelerator, and
in the training process, computational processing of the second input data that is next in the processing order after to the first input data in the accelerator. “Parallel” herein indicates that at least a part of the processing period of the communication processing and a part of the processing period of the computational processing overlap. For example, the communication processing may be started at a stage where at least a part of the computational processing has been performed. Additionally, “input data” herein refers to data of the micro-batch or processed data obtained by processing the micro-batch and input to the accelerator (data based on the micro-batch). Additionally, at least a part of the first input data and a part of the second input data may be the same data (or all data may be the same data).

The transmission unit 303 transmits the schedule generated by the scheduling unit 302 to the server device group 110.

### <Specific Example of Scheduling>

Next, a specific example of scheduling by the scheduling unit 302 will be described.

### (1) Outline of Intra-Layer Scheduling

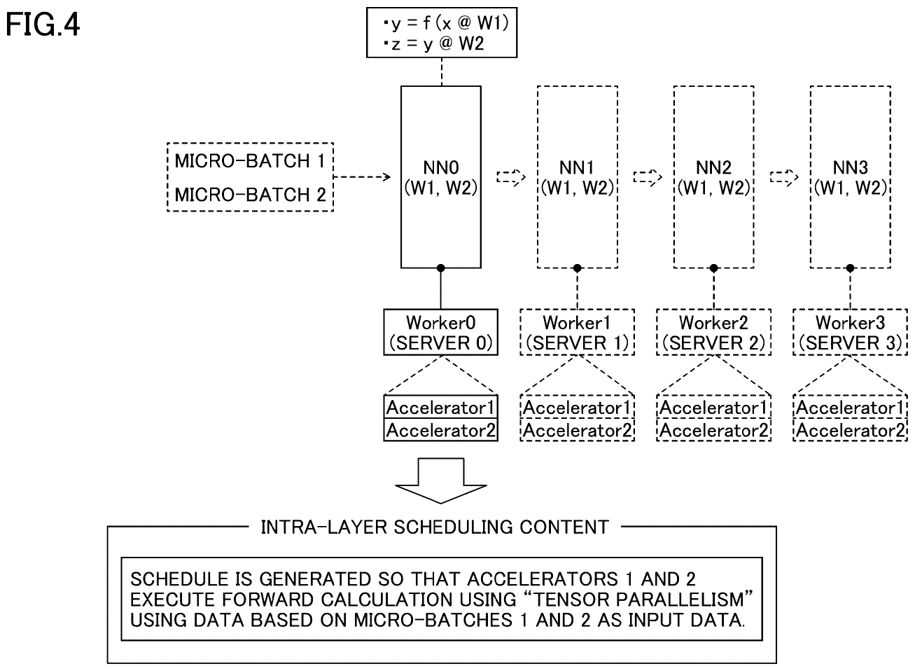

First, an outline of the intra-layer scheduling performed by the scheduling unit 302 will be described. FIG. 4 is a diagram illustrating an outline of the scheduling by the information processing device according to the first embodiment.

As illustrated in FIG. 4, in the first embodiment, the model to be trained includes four layers from “NN0” to “NN3”. The example of FIG. 4 indicates a state in which a worker whose name is “Worker0” is assigned to a training process for the layer “NN0”, and a worker whose name is “Worker1” is assigned to a training process for the layer “NN1”. Additionally, the example of FIG. 4 indicates a state in which a worker whose name is “Worker2” is assigned to a training process for the layer “NN2”, and a worker whose name is “Worker3” is assigned to a training process for the layer “NN3”.

In the example of FIG. 4, each worker is one server device (for example, server 0), and includes two accelerators (Accelerators 1 and 2). In the training process for the layer “NN0”, data based on Micro-batch 1 and data based on Micro-batch 2 are input into the layer “NN0” as the input data, and the two accelerators perform the following computational processing as forward calculation.

$$y = f ( x @ W 1 ) \\ z = y @ W 2$$

where
x: input data,
W1, W2: weight parameters of layer “NN0”,
@: matrix product operator,
f: a predetermined activation function,
   Here, it is assumed that x is an L×C matrix, W1 is a C×4C matrix, W2 is a 4C×C matrix, y is an L×4C matrix, and z is an L×C matrix.

The scheduling unit 302 generates a schedule so that the accelerators (Accelerators 1 and 2) use the data based on the Micro-batches 1 and 2 as input data to execute forward calculation using tensor parallelism. Here, the example of FIG. 4 indicates the case where the schedule in the layer “NN0” is generated is illustrated, but the same applies to the case where the schedules in the layers “NN1” to “NN3” are generated.

The schedule generated as described is transmitted to the server device group 110 and distributed to each worker as described above. The distribution method to each worker is suitably selected. For example, when the schedule is generated in a server device different from each worker, the different server device distributes the schedule to each worker. Additionally, when the schedule is generated in one of the workers, the one worker distributes the schedule to another worker. Additionally, when the same schedule is generated in each worker, each worker extracts a corresponding part of the schedule.

### (2) Scheduling by Scheduling Unit of Comparative Example

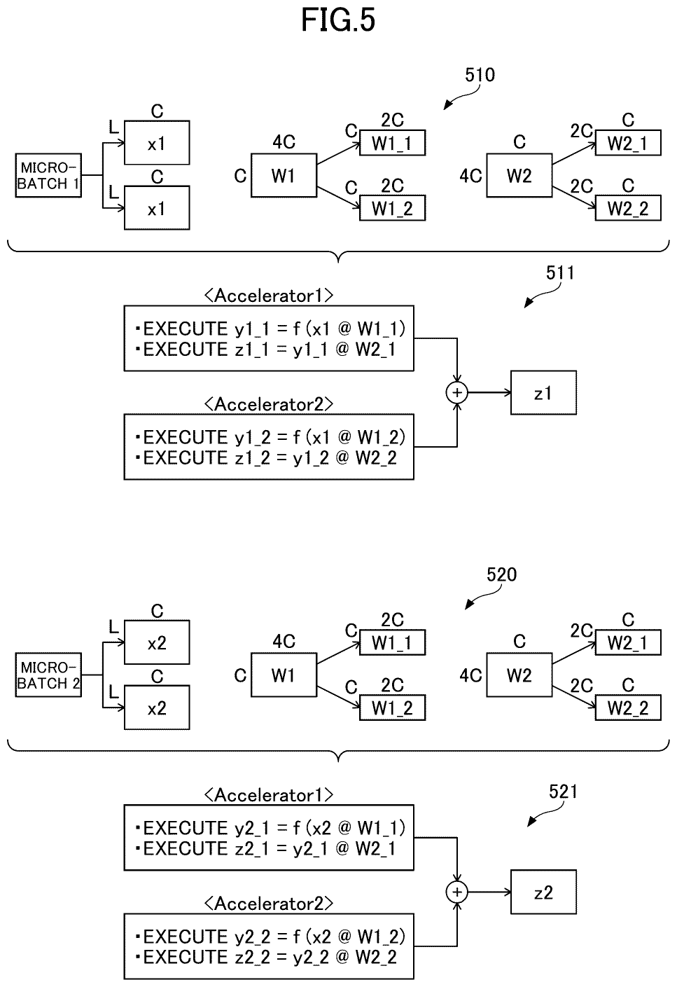

Next, a schedule generated by a scheduling unit of a comparative example will be described based on the outline of the intra-layer scheduling illustrated in FIG. 4. The scheduling unit of the comparative example is a generic name for a general scheduling unit configured to generate a schedule so as to execute forward calculation using tensor parallelism. In order to clarify the difference between the schedule generated by the scheduling unit 302 of the information processing device 120 and a general schedule, the scheduling by the scheduling unit of the comparative example will be described first. FIG. 5 is a first diagram illustrating a specific example of the scheduling by the scheduling unit of the comparative example.

As indicated by reference numeral 510, in order to enable tensor parallelism, the scheduling unit of the comparative example generates data x1 (L×C matrix) based on Micro-batch 1 in accordance with the number of accelerators (here, the number of generated data=2). This enables each of the accelerators to process the data x1 (L×C matrix) based on Micro-batch 1.

Additionally, as indicated by reference numeral 510, in order to enable tensor parallelism, the scheduling unit of the comparative example partitions each of the weight parameters W1 (C×4C matrix) and W2 (4C×C matrix) in accordance with the number of accelerators (here, the number of partitions=2). This can generate W1_1 and W1_2 (C×2C matrix), and W2_1 and W2_2 (2C×C matrix) after the partitioning that are assigned to the respective accelerators.

Subsequently, as indicated by reference numeral 511, the scheduling unit of the comparative example assigns processing to Accelerators 1 and 2. The example of reference numeral 511 indicates a state in which

$$y 1 \_ 1 = f ( x 1 @ W1\_ 1 ) , and \\ z 1 \_ 1 = y 1 \_ 1 @ W2\_ 1 ,$$

are assigned to Accelerator 1, and

$$y 1 \_ 2 = f ( x 1 @ W1\_ 2 ) , and \\ z 1 \_ 2 = y 1 \_ 2 @ W2\_ 2 ,$$

are assigned to Accelerator 2. Here, y1_1 and y1_2 are L×2C matrices, and z1_1 and z1_2 are L×C matrices.

Additionally, the example of reference numeral 511 indicates how z1 (L×C matrix) is calculated by summing z1_1 (L×C matrix) and z1_2 (L×C matrix) calculated by the processing in Accelerators 1 and 2. For example, when z1_1 (L×C matrix) and z1_2 (L×C matrix) are summed in Accelerators 1 and 2, z1_1 (L×C matrix) is transmitted from Accelerator 1 to Accelerator 2. Additionally, z1_2 (L×C matrix) is transmitted from Accelerator 2 to Accelerator 1. That is, communication processing occurs between the accelerators. Here, z1 is used as x1 of the next layer.

Subsequently, the scheduling unit of the comparative example similarly performs scheduling for Micro-batch 2.

As indicated by reference numeral 520, in order to enable tensor parallelism, the scheduling unit of the comparative example generates data x2 (L×C matrix) based on Micro-batch 2 in accordance with the number of accelerators (here, the number of generated data=2). This enables each of accelerators to process the data x2 (L×C matrix) based on Micro-batch 2.

Additionally, as indicated by reference numeral 520, in order to enable tensor parallelism, the scheduling unit of the comparative example partitions each of the weight parameters W1 (C×4C matrix) and W2 (4C×C matrix) in accordance with the number of accelerators (here, the number of partitions=2). This can generate W1_1 and W1_2 (C×2C matrix), and W2_1 and W2_2 (2C×C matrix) after the partitioning that are assigned to the respective accelerators.

Subsequently, as indicated by reference numeral 521, the scheduling unit of the comparative example assigns processing to Accelerators 1 and 2. The example of reference numeral 521 indicates a state in which

$$y 2 \_ 1 = f ( x 2 @ W1\_ 1 ) and \\ z 2 \_ 1 = y 2 \_ 1 @ W2\_ 1$$

are assigned to Accelerator 1, and

$$y 2 \_ 2 = f ( x 2 @ W1\_ 2 ) and \\ z 2 \_ 2 = y 2 \_ 2 @ W2\_ 2$$

are assigned to Accelerator 2. Here, y2_1 and y2_2 are L×2C matrices, and z2_1 and z2_2 are L×C matrices.

Additionally, the example of reference numeral 521 illustrates how z2 (L×C matrix) is calculated by summing z2_1 (L×C matrix) and z2_2 (L×C matrix) calculated by the processing in Accelerators 1 and 2. For example, when z2_1 (L×C matrix) and z2_2 (L×C matrix) are summed in Accelerators 1 and 2, z2_1 (L×C matrix) is transmitted from Accelerator 1 to Accelerator 2. Additionally, z2_2 (L×C matrix) is transmitted from Accelerator 2 to Accelerator 1. In other words, communication processing occurs between the accelerators. That is, z2 is used as x2 of the next layer.

### (3) Scheduling 1 by Scheduling Unit 302

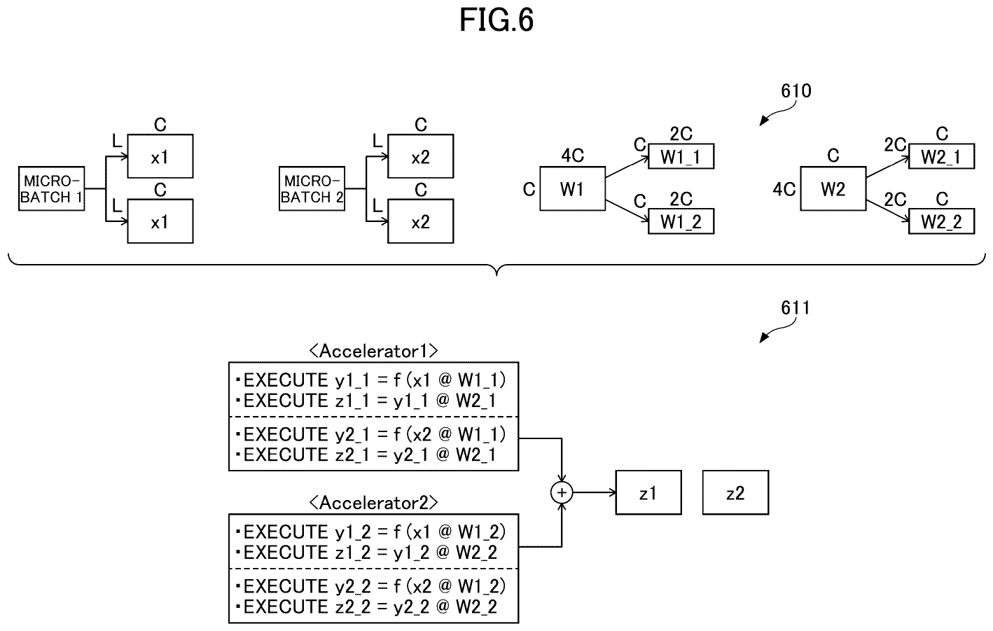

Next, a schedule generated by the scheduling unit 302 of the information processing device 120 according to the first embodiment will be described. FIG. 6 is a first diagram illustrating a specific example of scheduling by the scheduling unit of the information processing device according to the first embodiment.

As indicated by reference numeral 610, in order to enable tensor parallelism, the scheduling unit 302 generates data x1 (L×C matrix) based on Micro-batch 1 in accordance with the number of accelerators (here, the number of generated data=2).

At this time, the scheduling unit 302 schedules, as a group, the processing for the data based on the two micro-batches (Micro-batches 1 and 2). Thus, the scheduling unit 302 generates data x2 (L×C matrix) based on Micro-batch 2 in accordance with the number of accelerators (here, the number of generated data=2).

Additionally, as indicated by reference numeral 610, in order to enable tensor parallelism, the scheduling unit 302 partitions each of the weight parameters W1 (C×4C matrix) and W2 (4C×C matrix) in accordance with the number of accelerators (here, the number of partitions=2). This can generate W1_1 and W1_2 (C×2C matrix), and W2_1 and W2_2 (2C×C matrix) after the partitioning that are assigned to the respective accelerators.

Subsequently, as indicated by reference numeral 611, the scheduling unit 302 assigns the processing in Accelerators 1 and 2. The example of reference numeral 611 indicates a state in which

$$y 1 \_ 1 = f ( x 1 @ W1\_ 1 ) and \\ z 1 \_ 1 = y 1 \_ 1 @ W2\_ 1$$

are assigned to Accelerator 1, and

$$y 1 \_ 2 = f ( x 1 @ W1\_ 2 ) and \\ z 1 \_ 2 = y1\_ 2 @ W2\_ 2$$

are assigned to Accelerator 2. Here, y1_1 and y1_2 are L×2C matrices, and z1_1 and z1_2 are L×C matrices.

Additionally, the example of reference numeral 611 indicates how z1 (L×C matrix) is calculated by summing z1_1 (L×C matrix) and z1_2 (L×C matrix) calculated by the processing in Accelerators 1 and 2. For example, when z1_1 (L×C matrix) and z1_2 (L×C matrix) are summed in Accelerators 1 and 2, z1_1 (L×C matrix) is transmitted from Accelerator 1 to Accelerator 2. Additionally, z1_2 (L×C matrix) is transmitted from Accelerator 2 to Accelerator 1. That is, communication processing occurs between the accelerators.

Here, the scheduling unit 302 performs scheduling so that each accelerator executes the computational processing for the data based on the next micro-batch (Micro-batch 2) in parallel while the communication processing is performed between the accelerators.

The example of reference numeral 611 indicates a state in which, while the communication processing is performed between the accelerators,

$$y 2 \_ 1 = f ( x2 @ W1\_ 1 ) , and \\ z 2 \_ 1 = y2\_ 1 @ W2\_ 1$$

are assigned to Accelerator 1, and

$$y 2 \_ 2 = f ( x 2 @ W1\_ 2 ) , and \\ z 2 \_ 2 = y2\_ 2 @ W2\_ 2 ,$$

are assigned to Accelerator 2. Here, y2_1 and y2_2 are L×2C matrices, and z2_1 and z2_2 are L×C matrices.

Additionally, the example of reference numeral 611 indicates how z2 (L×C matrix) is calculated by summing z2_1 (L×C matrix) and z2_2 (L×C matrix) that are calculated by the processing in Accelerators 1 and 2. For example, when z2_1 (L×C matrix) and z2_2 (L×C matrix) are summed in Accelerators 1 and 2, z2_1 (L×C matrix) is transmitted from Accelerator 1 to Accelerator 2. Additionally, z2_2 (L×C matrix) is transmitted from Accelerator 2 to Accelerator 1. That is, communication processing occurs between the accelerators.

Here, while the communication processing is performed between the accelerators, the scheduling unit 302 performs scheduling so that each accelerator executes the processing for the data based on the next micro-batch in parallel. Here, in FIG. 6, data based on the next micro-batch (Micro-batch 3) is not illustrated for the sake of space, but processing for the data based on two micro-batches (Micro-batches 2 and 3) is also similarly scheduled as a group.

As described, the scheduling unit 302 can execute computational processing:

$$y = f ( x @ W 1 ) \\ z = y @ W 2$$

and communication processing between accelerators in parallel, by scheduling, as a group, processing for data based on two micro-batches adjacent in the processing order. As a result, according to the scheduling unit 302, the execution speed when the training process is performed using tensor parallelism can be improved.

Here, although the processing in the next layer is not illustrated in the example of FIG. 6, z1 (L×C matrix) and z2 (L×C matrix) calculated in Accelerators 1 and 2 are used as x1 and x2 in the next layer. Therefore, similarly in the next layer, computational processing:

$$y = f ( x @ W 1 ) \\ z = y @ W 2$$

and communication processing between the accelerators can be executed in parallel.

### (4) Scheduling 2 by Scheduling Unit 302

Next, another schedule generated by the scheduling unit 302 of the information processing device 120 according to the first embodiment will be described.

In (3) above, it is assumed that the worker with worker name=“Worker0” is a single server device (Server 0) and includes two accelerators. Here, a case where there are eight accelerators (referred to as Accelerator 1_1 to 2_4) will be described. In (3) above, two pieces of data x1 based on Micro-batch 1 are generated and two pieces of data x2 based on Micro-batch 2 are generated. In this case, four pieces of data are generated for each of the data x1 and data x2, and each of the four pieces of data is partitioned into two. Similarly, in (3) above, the weight parameters W1 and W2 are each partitioned into two, but in this case, the weight parameters W1 and W2 are each partitioned into four and further partitioned into two.

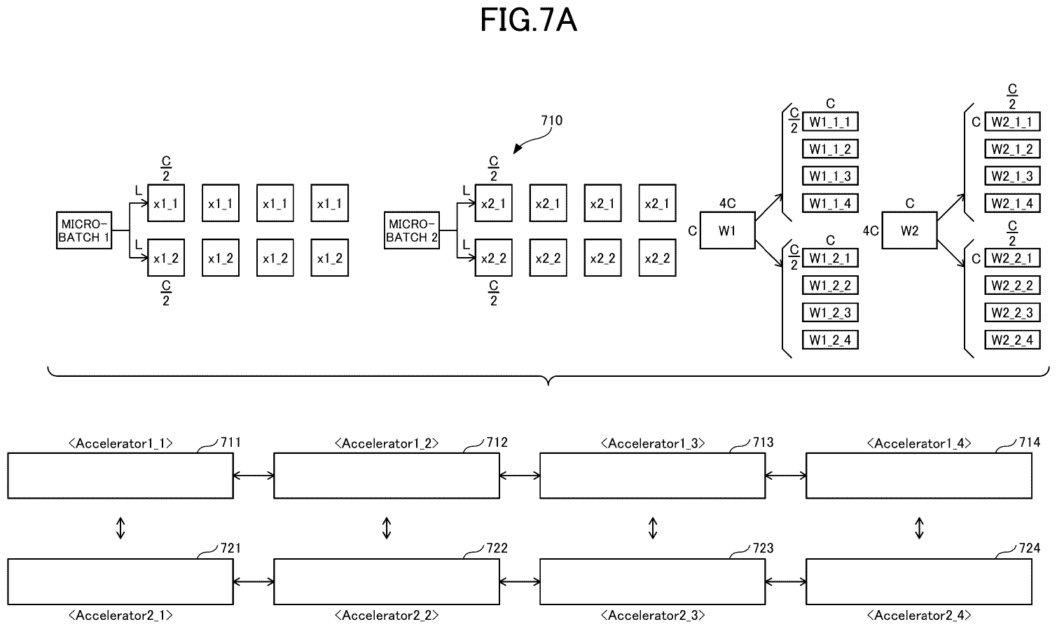

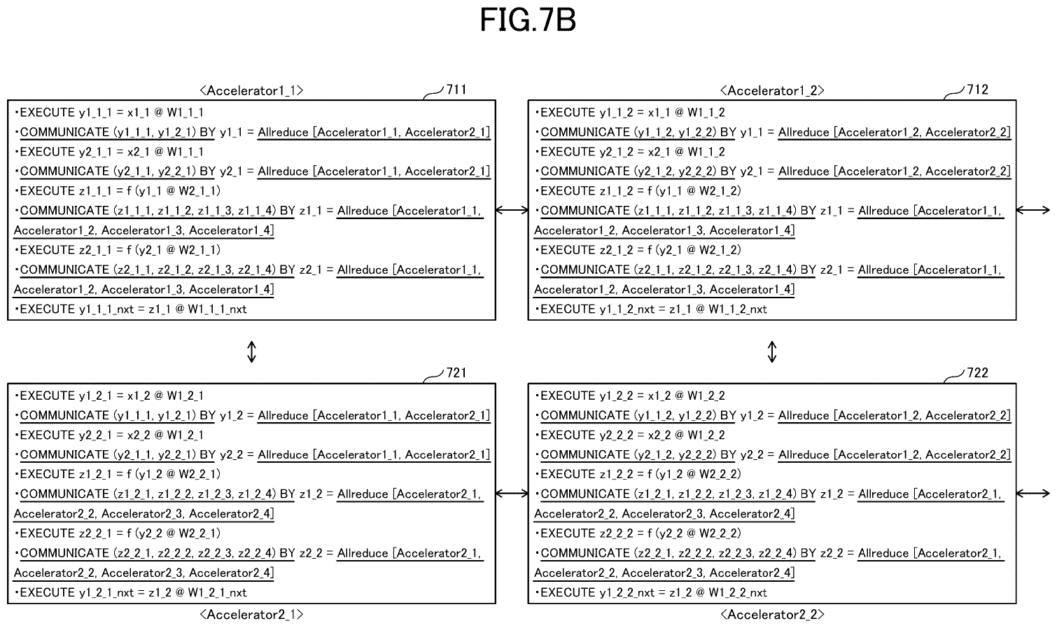

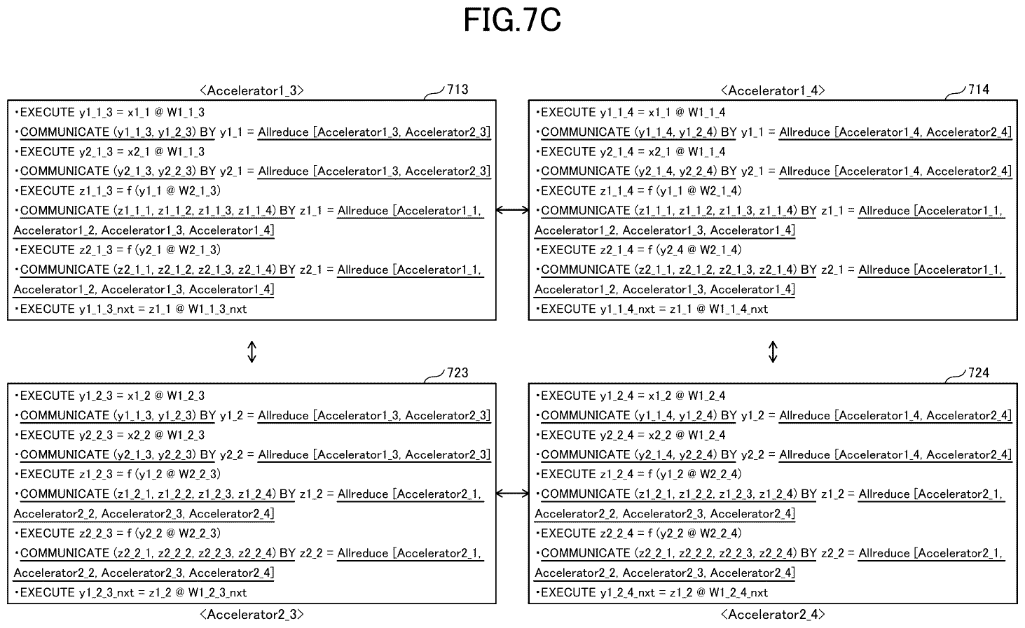

FIGS. 7A to 7C are second to fourth diagrams illustrating a specific example of the scheduling by the scheduling unit of the information processing device according to the first embodiment.

As indicated by reference numeral 710, in order to enable tensor parallelism, the scheduling unit 302 generates data based on Micro-batch 1 in accordance with the number of accelerators (here, eight pieces of data are generated). Specifically, four pieces of data x1 (L×C matrices) based on Micro-batch 1 are generated and each of the four pieces of data x1 is partitioned into two to generate four pieces of x1_1 (L×(C/2) matrices) and four pieces of x1_2 (L×(C/2) matrices).

Similarly, the scheduling unit 302 generates data based on Micro-batch 2 in accordance with the number of accelerators (here, eight pieces of data are generated). Specifically, four pieces of data x2 (L×C matrices) based on Micro-batch 2 are generated and each of the four pieces of data x2 (L×C matrices) is partitioned into two to generate four x2_1 (L×(C/2) matrices) and four x2_2 (L×(C/2) matrices).

Additionally, as indicated by reference numeral 710, in order to enable tensor parallelism, the scheduling unit 302 partitions each of the weight parameters W1 (C×4C matrix) and W2 (4C×C matrix) in accordance with the number of accelerators (here, after four partitions, two partitions are further performed). With this, the scheduling unit 302 can generate partitioned weight parameters W1_1a_1 to W1_1_4 ((C/2)×C matrices) and W1_2_1 to W1_2_4 ((C/2)×C matrices), which are assigned to the respective accelerators. Additionally, the scheduling unit 302 can generate weight parameters W2_1_1 to W2_1_4 (C×(C/2) matrices) and W2_2_1 to W2_2_4 (C×(C/2) matrices).

Subsequently, the scheduling unit 302 assigns the processing in Accelerators 1_1 to 2_4 (reference numeral 711 to 724).

As illustrated in FIG. 7B, the examples of reference numerals 711, 712, 721, and 722 indicate that

$$y 1 \_ 1 \_ 1 = x1\_ 1 @ W 1 \_ 1 \_ 1 , \\ y 1 \_ 1 = Allreduce [ Accelerator 1 \_ 1 , 2 \_ 1 ] , \\ y 2 \_ 1 \_ 1 = x2\_ 1 @ W 1 \_ 1 \_ 1 , \\ y 2 \_ 1 = Allreduce [ Accelerator 1 \_ 1 , 2 \_ 1 ] , \\ z 1 \_ 1 \_ 1 = f ( y1\_ 1 @ W 2 \_ 1 \_ 1 ) , \\ z1\_ 1 = Allreduce [ Accelerator 1 \_ 1 , 1 \_ 2 , 1 \_ 3 , 1 \_ 4 ] , \\ z 2 \_ 1 \_ 1 = f ( y2\_ 1 @ W 2 \_ 1 \_ 1 ) , \\ z2\_ 1 = Allreduce [ Accelerator 1 \_ 1 , 1 \_ 2 , 1 \_ 3 , 1 \_ 4 ] , \\ y 1 \_ 1 \_ 1 \_nxt = z1\_ 1 @ W 1 \_ 1 \_ 1 \_nxt$$

are assigned to Accelerator 1_1,

$$y 1 \_ 1 \_ 1 = x 1 \_ 1 @ W 1 \_ 1 \_ 1 , \\ y 1 \_ 1 = Allreduce [ Accelerator 1 \_ 1 , 2 \_ 1 ] , \\ y 2 \_ 1 \_ 1 = x 2 \_ 1 @ W 1 \_ 1 \_ 1 , \\ y 2 \_ 1 = Allreduce [ Accelerator 1 \_ 1 , 2 \_ 1 ] , \\ z 1 \_ 1 \_ 1 = f ( y 1 \_ 1 @ W 2 \_ 1 \_ 1 , \\ z 1 \_ 1 = Allreduce [ Accelerator 1 \_ 1 , 1 \_ 2 , 1 \_ 3 , 1 \_ 4 ] , \\ z 2 \_ 1 \_ 1 = f ( y 2 \_ 1 @ W 2 \_ 1 \_ 1 , \\ z 2 \_ 1 = Allreduce [ Accelerator 1 \_ 1 , 1 \_ 2 , 1 \_ 3 , 1 \_ 4 ] , \\ y 1 \_ 1 \_ 1 \_nxt = z 1 \_ 1 @ W 1 \_ 1 \_ 1 \_nxt$$

are assigned to Accelerator 1_2,

$$y 1 \_ 2 \_ 1 = x1\_ 2 @ W 1 \_ 2 \_ 1 , \\ y 1 \_ 2 = Allreduce [ Accelerator 1 \_ 1 , 2 \_ 1 ] , \\ y 2 \_ 2 \_ 1 = x2\_ 2 @ W 1 \_ 2 \_ 1 , \\ y 2 \_ 2 = Allreduce [ Accelerator 1 \_ 1 , 2 \_ 1 ] , \\ z 1 \_ 2 \_ 1 = f ( y1\_ 2 @ W 2 \_ 2 \_ 1 ) , \\ z1\_ 2 = Allreduce [ Accelerator 2 \_ 1 , 2 \_ 2 , 2 \_ 3 , 2 \_ 4 ] , \\ z 2 \_ 2 \_ 1 = f ( y2\_ 2 @ W 2 \_ 2 \_ 1 ) , \\ z2\_ 2 = Allreduce [ Accelerator 2 \_ 1 , 2 \_ 2 , 2 \_ 3 , 2 \_ 4 ] , \\ y 1 \_ 2 \_ 1 \_nxt = z1\_ 2 @ W 1 \_ 2 \_ 1 \_nxt$$

are assigned to Accelerator 2_1, and

$$y 1 \_ 2 \_ 2 = x1\_ 2 @ W 1 \_ 2 \_ 2 , \\ y 1 \_ 2 = Allreduce [ Accelerator 1 \_ 2 , 2 \_ 2 ] , \\ y 2 \_ 2 \_ 2 = x2\_ 2 @ W 1 \_ 2 \_ 2 , \\ y 2 \_ 2 = Allreduce [ Accelerator 1 \_ 2 , 2 \_ 2 ] , \\ z 1 \_ 2 \_ 2 = f ( y1\_ 2 @ W 2 \_ 2 \_ 2 ) , \\ z1\_ 2 = Allreduce [ Accelerator 2 \_ 1 , 2 \_ 2 , 2 \_ 3 , 2 \_ 4 ] , \\ z 2 \_ 2 \_ 2 = f ( y2\_ 2 @ W 2 \_ 2 \_ 2 ) , \\ z2\_ 2 = Allreduce [ Accelerator 2 \_ 1 , 2 \_ 2 , 2 \_ 3 , 2 \_ 4 ] , \\ y 1 \_ 2 \_ 2 \_nxt = z1\_ 2 @ W 1 \_ 2 \_ 2 \_nxt$$

are assigned to Accelerator 2_2. Here, y1_1_1, y1_1_2, y1_2_1, and y1_2_2 are L×C matrices. y2_1_1, y2_1_2, y2_2_1, and y2_2_2 are L×C matrices. z1_1_1, z1_1_2, z1_2_1, and z1_2_2 are (L×(C/2)) matrices, and z1_1 and z2_1 are (L×(C/2)) matrices. z2_1_1, z2_1_2, z2_2_1, and z2_2_2 are (L×(C/2)) matrices, and z2_1 and z2_2 are (L×(C/2)) matrices. y1_1_1 next, y1_1_2 next, y1_2_1 next, and y1_2_2_next are L×C matrices.

By assigning the processing as described above, according to the scheduling unit 302, for example,
a process of communicating y1_1_1 and y1_2_1 in order to calculate y1_1 by Allreduce, and
a process of calculating y2_1_1, can be performed in parallel,
a process of communicating y2_1_1 and y2_2_1 in order to calculate y2_1 by Allreduce, and
a process of calculating z1_1_1, can be performed in parallel,
a process of communicating z1_1_1, z1_1_2, z1_1_3, and z1_1_4 in order to calculate z1_1 by Allreduce, and
a process of calculating z2_1_1, can be performed in parallel, and
a process of communicating z2_1_1, z2_1_2, z2_1_3, and z2_1_4 in order to calculate z2_1 by Allreduce;
a process of calculating y1_1_1 n×t of the next layer by using z1_1
   can be performed in parallel (see reference numeral 711).

Similarly, according to the scheduling unit 302, for example,
a process of communicating y1_1_2 and y1_2_2 in order to calculate y1_1 by Allreduce, and
a process of calculating y2_1_2, can be performed in parallel,
a process of communicating y2_1_2 and y2_2_2 in order to calculate y2_1 by Allreduce, and
a process of calculating z1_1_2, can be performed in parallel,
a process of communicating z1_1_1, z1_1_2, z1_1_3 and z1_1_4 in order to calculate z1_1 by Allreduce, and,
a process of calculating z2_1_2, can be performed in parallel, and
a process of communicating z2_1_1, z2_1_2, z2_1_3, and z2_1_4 in order to calculate z2_1 by Allreduce;
a process of calculating y1_1_2 n×t of the next layer by using z1_1
   can be performed in parallel (see reference numeral 712).

Similarly, according to the scheduling unit 302, for example,
a process of communicating y1_1_1 and y1_2_1 in order to calculate y1_2 by Allreduce, and
a process of calculating y2_2_1, can be performed in parallel,
a process of communicating y2_1_1 and y2_2_1 in order to calculate y2_2 by Allreduce, and
a process of calculating z1_2_1, can be performed in parallel,
a process of communicating z1_2_1, z1_2_2, z1_2_3, and z1_2_4 in order to calculate z1_2 by Allreduce, and
a process of calculating z2_2_1, can be performed in parallel, and
a process of communicating z2_2_1, z2_2_2, z2_2_3, and z2_2_4 in order to calculate z2_2 by Allreduce, and
a process of calculating y1_2_1_n×t of the next layer by using z1_2,
   can be performed in parallel (see reference numeral 721).

Similarly, according to the scheduling unit 302, for example,
a process of communicating y1_1_2 and y1_2_2 in order to calculate y1_2 by Allreduce, and
a process of calculating y2_2_2, can be performed in parallel,
a process of communicating y2_1_2 and y2_2_2 in order to calculate y2_2 by Allreduce, and
a process of calculating z1_2_2, can be performed in parallel,
a process of communicating z1_2_1, z1_2_2, z1_2_3 and z1_2_4 in order to calculate z1_2 by Allreduce, and
a process of calculating z2_2_2, can be performed in parallel, and
a process of communicating z2_2_1, z2_2_2, z2_2_3 and z2_2_4 in order to calculate z2_2 by Allreduce, and
a process of calculating y1_2_2_n×t of the next layer by using z1_2,
   can be performed in parallel (see reference numeral 722).

Additionally, as illustrated in FIG. 7C, examples of reference numeral 713, 714, 723, and 724 indicate that

$$y 1 \_ 1 \_ 2 = x 1 \_ 1 @ W 1 \_ 1 \_ 2 , \\ y 1 \_ 1 = Allreduce [ Accelerator 1 \_ 2 , 2 \_ 2 ] , \\ y 2 \_ 1 \_ 2 = x 2 \_ 1 @ W 1 \_ 1 \_ 2 , \\ y 2 \_ 1 = Allreduce [ Accelerator 1 \_ 2 , 2 \_ 2 ] , \\ z 1 \_ 1 \_ 2 = f ( y 1 \_ 1 @ W 2 \_ 1 \_ 2 , \\ z 1 \_ 1 = Allreduce [ Accelerator 1 \_ 1 , 1 \_ 2 , 1 \_ 3 , 1 \_ 4 ] , \\ z 2 \_ 1 \_ 2 = f ( y 2 \_ 1 @ W 2 \_ 1 \_ 2 , \\ z 2 \_ 1 = Allreduce [ Accelerator 1 \_ 1 , 1 \_ 2 , 1 \_ 3 , 1 \_ 4 ] , \\ y 1 \_ 1 \_ 2 \_nxt = z 1 \_ 1 @ W 1 \_ 1 \_ 2 \_nxt$$

are assigned to Accelerator 1_3,

$$y 1 \_ 1 \_ 4 = x1\_ 1 @ W 1 \_ 1 \_ 4 , \\ y 1 \_ 1 = Allreduce [ Accelerator 1 \_ 4 , 2 \_ 4 ] , \\ y 2 \_ 1 \_ 4 = x2\_ 1 @ W 1 \_ 1 \_ 4 , \\ y 2 \_ 1 = Allreduce [ Accelerator 1 \_ 4 , 2 \_ 4 ] , \\ z 1 \_ 1 \_ 4 = f ( y1\_ 1 @ W 2 \_ 1 \_ 4 ) , \\ z1\_ 1 = Allreduce [ Accelerator 1 \_ 1 , 1 \_ 2 , 1 \_ 3 , 1 \_ 4 ] , \\ z 2 \_ 1 \_ 4 = f ( y2\_ 4 @ W 2 \_ 1 \_ 4 ) , \\ z2\_ 1 = Allreduce [ Accelerator 1 \_ 1 , 1 \_ 2 , 1 \_ 3 , 1 \_ 4 ] , \\ y 1 \_ 1 \_ 4 \_nxt = z1\_ 1 @ W 1 \_ 1 \_ 4 \_nxt$$

are assigned to Accelerator 1_4,

$$y 1 \_ 2 \_ 3 = x1\_ 1 @ W 1 \_ 2 \_ 3 , \\ y 1 \_ 2 = Allreduce [ Accelerator 1 \_ 3 , 2 \_ 3 ] , \\ y 2 \_ 2 \_ 3 = x2\_ 2 @ W 1 \_ 2 \_ 3 , \\ y 2 \_ 2 = Allreduce [ Accelerator 1 \_ 3 , 2 \_ 3 ] , \\ z 1 \_ 2 \_ 3 = f ( y1\_ 2 @ W 2 \_ 2 \_ 3 ) , \\ z1\_ 2 = Allreduce [ Accelerator 2 \_ 1 , 2 \_ 2 , 2 \_ 3 , 2 \_ 4 ] , \\ z 2 \_ 2 \_ 3 = f ( y2\_ 2 @ W 2 \_ 2 \_ 3 ) , \\ z2\_ 2 = Allreduce [ Accelerator 2 \_ 1 , 2 \_ 2 , 2 \_ 3 , 2 \_ 4 ] , \\ y 1 \_ 2 \_ 3 \_nxt = z1\_ 2 @ W 1 \_ 2 \_ 3 \_nxt$$

are assigned to Accelerator 2_3, and

$$y 1 \_ 2 \_ 4 = x1\_ 1 @ W 1 \_ 2 \_ 4 , \\ y 1 \_ 2 = Allreduce [ Accelerator 1 \_ 4 , 2 \_ 4 ] , \\ y 2 \_ 2 \_ 4 = x2\_ 1 @ W 1 \_ 2 \_ 4 , \\ y 2 \_ 2 = Allreduce [ Accelerator 1 \_ 4 , 2 \_ 4 ] , \\ z 1 \_ 2 \_ 4 = f ( y1\_ 2 @ W 2 \_ 2 \_ 4 ) , \\ z1\_ 2 = Allreduce [ Accelerator 2 \_ 1 , 2 \_ 2 , 2 \_ 3 , 2 \_ 4 ] , \\ z 2 \_ 2 \_ 4 = f ( y2\_ 2 @ W 2 \_ 2 \_ 4 ) , \\ z2\_ 2 = Allreduce [ Accelerator 2 \_ 1 , 2 \_ 2 , 2 \_ 3 , 2 \_ 4 ] , \\ y 1 \_ 2 \_ 4 \_nxt = z1\_ 2 @ W 1 \_ 2 \_ 4 \_nxt$$

are assigned to Accelerator 2_4. Here, y1_1_3, y1_1_4, y1_2_3, and y1_2_4 are L×C matrices. y2_1_3, y2_1_4, y2_2_3, and y2_2_4 are L×C matrices. z1_1_3, z1_1_4, z1_2_3, and z1_2_4 are (L×(C/2)) matrices, and z1_1 and z2_1 are (L×(C/2)) matrices. z2_1_3, z2_1_4, z2_2_3, and z2_2_4 are (L×(C/2)) matrices, and z2_1 and z2_2 are (L×(C/2)) matrices. y1_1_3_next, y1_1_4_next, y1_2_3_next, and y1_2_4_next are L×C matrices.

By assigning the processing as described above, according to the scheduling unit 302, for example,
a process of communicating y1_1_3 and y1_2_3 in order to calculate y1_1 by Allreduce, and
a process of calculating y2_1_3, can be performed in parallel,
a process of communicating y2_1_3 and y2_2_3 in order to calculate y2_1 by Allreduce, and
a process of calculating z1_1_3, can be performed in parallel,
a process of communicating z1_1_1, z1_1_2, z1_1_3, and z1_1_4 in order to calculate z1_1 by Allreduce, and
a process of calculating z2_1_3, can be performed in parallel, and
a process of communicating z2_1_1, z2_1_2, z2_1_3, and z2_1_4 in order to calculate z2_1 by Allreduce, and
a process of calculating y1_1_3_n×t of the next layer by using z1_1, can be performed in parallel (see reference numeral 713).

Similarly, according to the scheduling unit 302, for example,
a process of communicating y1_1_4 and y1_2_4 in order to calculate y1_1 by Allreduce, and
a process of calculating y2_1_4, can be performed in parallel,
a process of communicating y2_1_4 and y2_2_4 in order to calculate y2_1 by Allreduce, and
a process of calculating z1_1_4, can be executed in parallel.
a process of communicating z1_1_1, z1_1_2, z1_1_3, and z1_1_4 in order to calculate z1_1 by Allreduce, and
a process of calculating z2_1_4, can be performed in parallel, and
a process of communicating z2_1_1, z2_1_2, z2_1_3, and z2_1_4 in order to calculate z2_1 by Allreduce, and
a process of calculating y1_1_4 n×t of the next layer by using z1_1, can be performed in parallel (see reference numeral 714).

Similarly, according to the scheduling unit 302, for example,
a process of communicating y1_1_3 and y1_2_3 in order to calculate y1_2 by Allreduce, and
a process of calculating y2_2_3, can be performed in parallel,
a process of communicating y2_1_3 and y2_2_3 in order to calculate y2_2 by Allreduce, and
a process of calculating z1_2_3, can be performed in parallel,
a process of communicating z1_2_1, z1_2_2, z1_2_3 and z1_2_4 in order to calculate z1_2 by Allreduce, and
a process of calculating z2_2_3, can be performed in parallel,
a process of communicating z2_2_1, z2_2_2, z2_2_3 and z2_2_4 in order to calculate z2_2 by Allreduce, and
a process of calculating y1_2_3 n×t of the next layer by using z1_2,
   can be performed in parallel (see reference numeral 723).

Similarly, according to the scheduling unit 302, for example,
a process of communicating y1_1_4 and y1_2_4 in order to calculate y1_2 by Allreduce, and
a process of calculating y2_2_4, can be performed in parallel,
a process of communicating y2_1_4 and y2_2_4 in order to calculate y2_2 by Allreduce, and
a process of calculating z1_2_4, can be performed in parallel,
a process of communicating z1_2_1, z1_2_2, z1_2_3, and z1_2_4 in order to calculate z1_2 by Allreduce, and
a process of calculating z2_2_4,
   can be performed in parallel,
a process of communicating z2_2_1, z2_2_2, z2_2_3, and z2_2_4 in order to calculate z2_2 by Allreduce, and
a process of calculating y1_2_4 n×t of the next layer by using z1_2,
   can be performed in parallel (see reference numeral 724).

### Summary

As is clear from the above description, the information processing device 120 according to the first embodiment assigns processes to a plurality of accelerators used for tensor parallelism so as to execute, in parallel, communication processing, between accelerators, of a result of executing computational processing using at least a part of a model for first input data and computational processing using at least a part of the model for second input data, in the scheduling of a training process performed using tensor parallelism for each layer of NN.

Additionally, the server device according to the first embodiment executes, in parallel, when performing a training process using tensor parallelism for each layer of NN, communication processing, between accelerators, of a result of executing computational processing using at least a part of the model for first input data and computational processing using at least a part of the model for second input data.

With this, according to the first embodiment, the execution speed of performing a training process using tensor parallelism can be improved in comparison with the case where computational processing of the next input data is performed after the computational processing of the previous input data is executed and the communication processing between accelerators is completed.

### Second Embodiment

In the first embodiment above, the scheduling of the training process performed using tensor parallelism, using data based on a plurality of micro-batches as input data for each layer of NN has been described. With respect to the above, in a second embodiment, scheduling of a training process performed using tensor parallelism, using data based on a plurality of micro-batches as input data in the decoder of the Transformer will be described. Here, the second embodiment will be described mainly on differences from the first embodiment described above.

### Specific Example of Scheduling

First, a specific example of scheduling by a scheduling unit 302 of an information processing device according to the second embodiment will be described.

### (1) Outline of Intra-Layer Scheduling

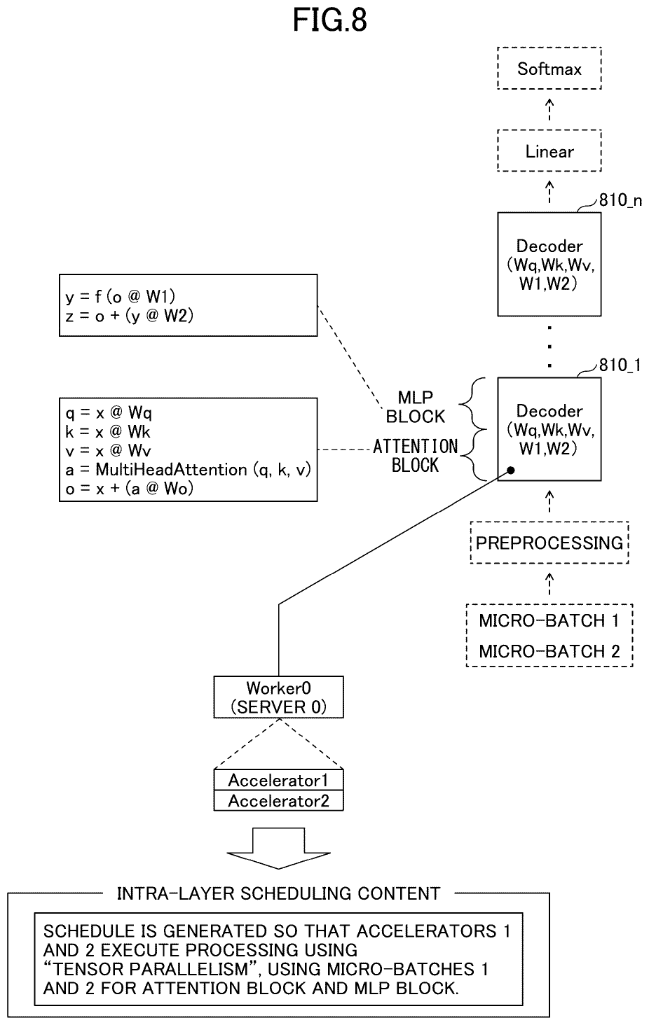

FIG. 8 is a diagram illustrating an outline of the scheduling by the information processing device according to the second embodiment. In FIG. 8, reference numerals 810_1 to 810_n indicate a plurality of decoders constituting the Transformer. The example of FIG. 8 indicates a state in which a worker whose name is “Worker0” is assigned to a training process in the decoder indicated by reference numeral 810_1. In the example of FIG. 8, the worker is a single server device (server 0) and includes two accelerators. The decoder indicated by reference numeral 810_1 is divided into an attention block and an MLP (multi-layer perceptron) block. When data based on Micro-batch 1 and data based on Micro-batch 2 are input as input data via a preprocessing unit, the attention block of the decoder indicated by reference numeral 810_1 executes the following calculation.

$$q = x @ Wq , \\ k = x @ Wk , \\ v = x @ Wv , a = MultiHeadAttention ( q , k , v ) \\ 0 = x + ( a @ Wo )$$

where:
   x: input data,
   Wq, Wk, Wv, and Wo: the weight parameters of the attention block,
   @: the matrix product operator.
      Here, it is assumed that x, q, k, v, a, and o are L×C matrices and Wq, Wk, Wv, and Wo are C×C matrices.

Additionally, it is assumed that the above calculation is executed in the attention block of the decoder indicated by reference numeral 810_1, and data o based on Micro-batches 1 and 2, which is processed data, is input as input data. In this case, the MLP block of the decoder indicated by reference numeral 810_1 executes the following calculation:

$$y = f ( o @ W 1 ) , \\ z = o + ( y @ W 2 )$$

where:
f: a predetermined activation function,
W1, W2: weight parameters of the MLP block.
   Here, it is assumed that W1 is a C×4C matrix, W2 is a 4C×C matrix, y is an L×4C matrix, and z is an L×C matrix.

As described, in the second embodiment, the scheduling unit 302 generates the schedule, using the data based on Micro-batches 1 and 2 as input data, so that the Accelerators 1 and 2 execute the respective calculations of the attention block and the MLP block by using tensor parallelism.

### (2) Scheduling by Scheduling Unit 302

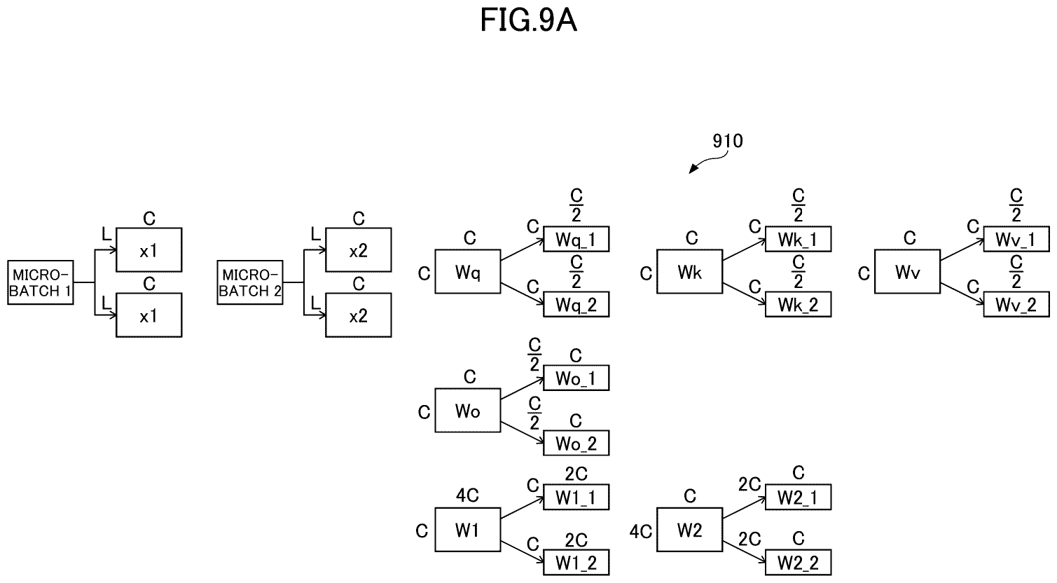

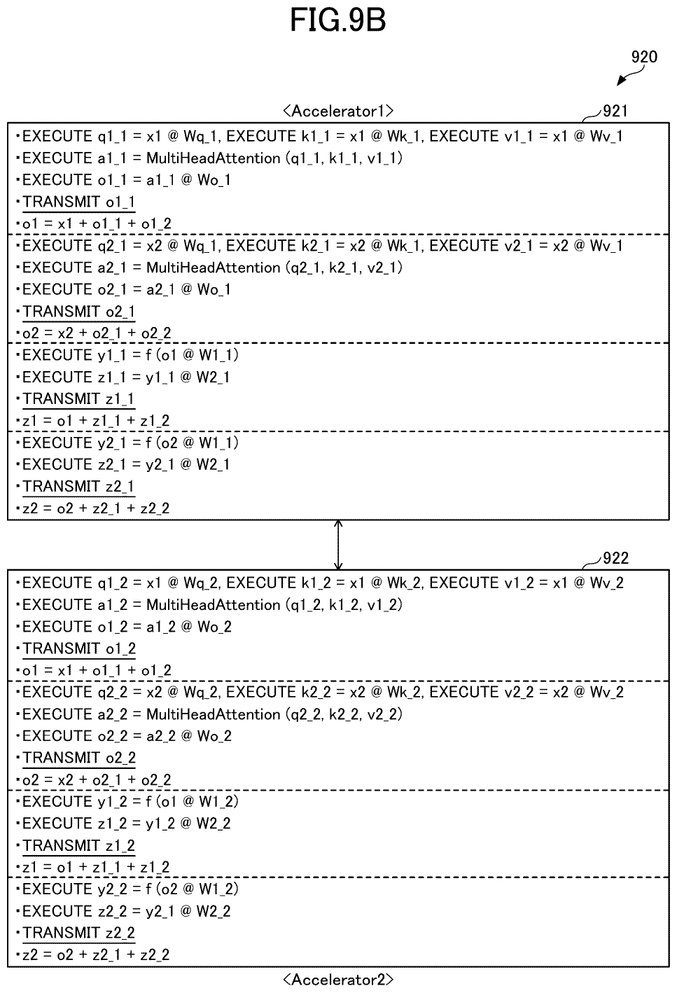

Next, details of the schedule generated by the scheduling unit 302 of the information processing device 120 according to the second embodiment will be described. FIGS. 9A and 9B are first and second diagrams illustrating specific examples of the scheduling by the scheduling unit of the information processing device according to the second embodiment.

As indicated by reference numeral 910 in FIG. 9A, in order to enable tensor parallelism, the scheduling unit 302 generates data x1 (L×C matrix) based on Micro-batch 1 in accordance with the number of accelerators (here, the number of generated data is 2).

At this time, the scheduling unit 302 schedules, as a group, the processing on the data based on the two micro-batches (Micro-batches 1 and 2). Thus, the scheduling unit 302 generates data x2 (L×C matrix) based on Micro-batch 2 in accordance with the number of accelerators (here, the number of generated data is 2).

Additionally, as indicated by reference numeral 910, in order to enable tensor parallelism, the scheduling unit 302 partitions the weight parameters Wq (C×C matrix), Wk (C×C matrix), and Wv (C×C matrix) in accordance with the number of accelerators (here, the number of partitions is 2). This generates Wq_1, Wq_2 (C×(C/2) matrices), Wk_1, Wk_2 (C×(C/2 matrices)), and Wv_1, Wv_2 (C×(C/2) matrices) after the partitioning to be assigned to the respective accelerators. Additionally, as indicated by reference numeral 910, in order to enable tensor parallelism, the scheduling unit 302 partitions the weight parameter Wo (C×C matrix) in accordance with the number of accelerators (here, the number of partitions=2). This generates Wo_1 and Wo_2 ((C/2)×C matrices) after the partitioning to be assigned to the respective accelerators.

Additionally, as indicated by reference numeral 910, in order to enable tensor parallelism, the scheduling unit 302 partitions the weight parameters W1 (C×4C matrix) and W2 (4C×C matrix) in accordance with the number of accelerators (here, the number of partitions=2). This generates W1_1, W1_2 (C×2C matrices), W2_1, and W2_2 (2C×C matrices) after the partitioning to be assigned to the respective accelerators.

Subsequently, as indicated by reference numeral 920 in FIG. 9B, the scheduling unit 302 assigns processing in the attention block. Examples of reference numerals 921 and 922 indicate a state in which

$$q {1}_{-} 1 = x 1 @ {Wq}_{-} 1 , k {1}_{-} 1 = x 1 @ {Wk}_{-} 1 , v {1}_{-} 1 = x 1 @ {Wv}_{-} 1 , \\ a {1}_{-} 1 = MultiHeadAttention ( q {1}_{-} 1 , k {1}_{-} 1 , v {1}_{-} 1 ) , \\ o {1}_{-} 1 = a {1}_{-} 1 @ {Wo}_{-} 1 , \\ transmit o {1}_{-} 1 to Accelerator 2 , o 1 = x 1 + o {1}_{-} 1 + o {1}_{-} 2 ,$$

are assigned to Accelerator 1, and

$$q 1 \_ 2 = x 1 @ Wq\_ 2 , k 1 \_ 2 = x 1 @ W k\_ 2 , v 1 \_ 2 = x 1 @ Wv\_ 2 ,$$

$$a l\_ 2 = MultiHeadAttention ( q 1 \_ 2 , k 1 \_ 2 , v 1 \_ 2 ) ,$$

$$o 1 \_ 2 = a 1 \_ 2 @ Wo\_ 2 ,$$

$$transmit o 1 \_ 2 to Accelerator 1 ,$$

$$o 1 = x 1 + o 1 \_ 1 + o 1 \_ 2 ,$$

are assigned to Accelerator 2.
Additionally, the examples of reference numerals 921 and 922 indicate a state in which

$$q {2}_{-} 1 = x 2 @ W {q}_{-} 1 , k {2}_{-} 1 = x 2 @ W {k}_{-} 1 , v {2}_{-} 1 = x 2 @ W {v}_{-} 1 , a {2}_{-} 1 = MultiHeadAttention ( q {2}_{-} 1 , k {2}_{-} 1 , v {2}_{-} 1 ) , 02 \_ 1 = a {2}_{-} 1 @ W {0}_{-} 1 , transmit {o 2}_{-} 1 to Accelerator 2 , o 2 = x 2 + o {2}_{-} 1 + o {2}_{-} 2 ,$$

are assigned to Accelerator 1, and

$$q 2 \_ 2 = x 2 @ Wq\_ 2 , k 2 \_ 2 = x 2 @ Wk\_ 2 , v 2 \_ 2 = x 2 @ Wv\_ 2 ,$$

$$a 2 \_ 2 = MultiHeadAttention ( q 2 \_ 2 , k 2 \_ 2 , v 2 \_ 2 ) ,$$

$$o 2 \_ 2 = a 2 \_ 2 @ Wo\_ 2 ,$$

$$transmit o 2 \_ 2 to Accelerator 1 ,$$

$$o 2 = x 2 + o 2 \_ 1 + o 2 \_ 2 ,$$

are assigned to Accelerator 2.

By assigning the processing in such a way, according to the scheduling unit 302, for example,
a process of communicating o1_1 and o1_2 calculated by using the data based on the previous micro-batch as input data between the Accelerator 1 and the Accelerator 2, and
a process of calculations up to o2_1=a2_1@Wo_1 or a process of calculations up to o2_2=a2_2@Wo_2, using the data based on the next micro-batch as input data,
   can be performed in parallel.

Subsequently, as indicated by reference numeral 920, the scheduling unit 302 assigns the processing in the MLP to the Accelerators 1 and 2. The examples of reference numerals 921 and 922 indicate a state in which

$$y {1}_{-} 1 = f ( 01 @ W1\_ 1 ) , \\ z {1}_{-} 1 = y {1}_{-} 1 @ W {2}_{-} 1 , transmit {z1}_{-} 1 to Accelerator 2 , z 1 = o 1 + z {1}_{-} 1 + z {1}_{-} 2 ,$$

are assigned to Accelerator 1, and

$$y 1 \_ 2 = f ( o 1 @ W 1 \_ 2 ) ,$$

$$z 1 \_ 2 = y 1 \_ 2 @ W 2 \_ 2 ,$$

$$z 1 \_ 2 is sent to Accelerator 1 ,$$

$$z 1 = o 1 + z 11 + z 12 ,$$

are assigned to Accelerator 2.

By assigning the processing in such a way, according to the scheduling unit 302, for example,
a process of communicating o2_1 and o2_2 calculated by using the data based on the next micro-batch as input data between the Accelerator 1 and the Accelerator 2, and
a process of calculations up to z1_1=y1_1@W2_1 or a process of calculations up to z1_2=y1_2@W2_2, using the data based on the previous micro-batch as input data,
   can be executed in parallel.

Subsequently, as indicated by reference numeral 920, the scheduling unit 302 assigns the processing in the MLP block to the Accelerators 1 and 2. The examples of reference numerals 921 and 922 indicate a state in which

$$y {2}_{-} 1 = f ( o 2 @ W 1 \_ 1 ) , \\ z {2}_{-} 1 = y 2 \_ 1 @ W 2 \_ 1 ) , \\ transmit {z2}_{-} 1 to Accelerator 2 , \\ z 2 = o 2 + z {2}_{-} 1 + z {2}_{-} 2 ,$$

are assigned to Accelerator 1, and

$$y 2 \_ 2 = f ( o 2 @ W 1 \_ 2 ) ,$$

$$z 2 \_ 2 = y 2 \_ 1 @ W 2 \_ 2 ,$$

$$transmit z 2 \_ 2 to Accelerator 1 ,$$

$$z 2 = o 2 + z 2 \_ 1 + z 2 \_ 2 ,$$

are assigned to Accelerator 2.

By assigning the processing in such a way, according to the scheduling unit 302, for example,
a process of communicating z1_1 and z1_2 calculated by using the data based on the previous micro-batch as input data between the Accelerator 1 and the Accelerator 2, and
a process of calculations up to z2_1=y2_1@W2_1 or a process of calculations up to z2_2=y2_1@W2_2, using the data based on the next micro-batch as input data,
   can be performed in parallel.

### Summary

As is clear from the above description, in the information processing device 120 according to the second embodiment, in the scheduling for the training process performed using tensor parallelism in the decoder of the Transformer,
the processing is assigned to a plurality of accelerators used for tensor parallelism so as to execute, in parallel, using data based on two micro-batches adjacent in the processing order as a set of input data, communication processing, between accelerators, of a result of executing computational processing for the first input data in the attention block and computational processing for the second input data in the attention block,
the processing is assigned to a plurality of accelerators used for tensor parallelism so as to execute, in parallel, using data based on two micro-batches as a set of input data, communication processing, between accelerators, of a result of executing computational processing for the second input data in the attention block and computational processing for the first input data in the MLP block, and
the processing is assigned to a plurality of accelerators used for tensor parallelism so as to execute, in parallel, using data based on two micro-batches as a set of input data, communication processing, between accelerators, of a result of executing computational processing for the first input data in the MLP block and computational processing for the second input data in the MLP block.

Additionally, in the server device according to the second embodiment, when the training process using tensor parallelism is performed in the decoder of the Transformer,
communication processing, between accelerators, of a result of executing computational processing for the first input data in the attention block, and computational processing for the second input data in the attention block are executed in parallel, using data based on two micro-batches adjacent in the processing order as a set of input data,
communication processing, between accelerators, of a result of executing computational processing for the second input data in the attention block and computational processing for the first input data in the MLP block are executed in parallel, using data based on two micro-batches adjacent in the processing order as a set of input data, and
communication processing, between accelerators, of a result of executing computational processing for the first input data in the MLP block and computational processing for the second input data in the MLP block are executed in parallel, using data based on two micro-batches adjacent in the processing order as a set of input data.

With this, according to the second embodiment, in comparison with the case where the computational processing of the previous input data is executed, the communication processing between accelerators is completed, and then the computational processing of the next input data is executed, the execution speed in performing the training process using tensor parallelism can be improved.

Here, in the present embodiment, the case where the training process is performed using tensor parallelism, using the data based on a plurality of micro-batches as input data in the decoder of Transformer has been described. However, when the Transformer includes an encoder, the training process using tensor parallelism may be performed by substantially the same method in the encoder.

### Third Embodiment

In the second embodiment described above, the scheduling in the case where the training process is performed using tensor parallelism, using the data based on a plurality of micro-batches as input data in the decoder of the Transformer has been described. With respect to the above, in a third embodiment, scheduling in a case where a training process is performed using sequence parallelism, using data based on a plurality of micro-batches as input data in the decoder of the Transformer will be described. Here, the third embodiment will be described mainly on differences from the second embodiment described above.

### Specific Example of Scheduling

First, a specific example of scheduling by a scheduling unit 302 of an information processing device according to the third embodiment will be described.

### (1) Outline of Intra-Layer Scheduling

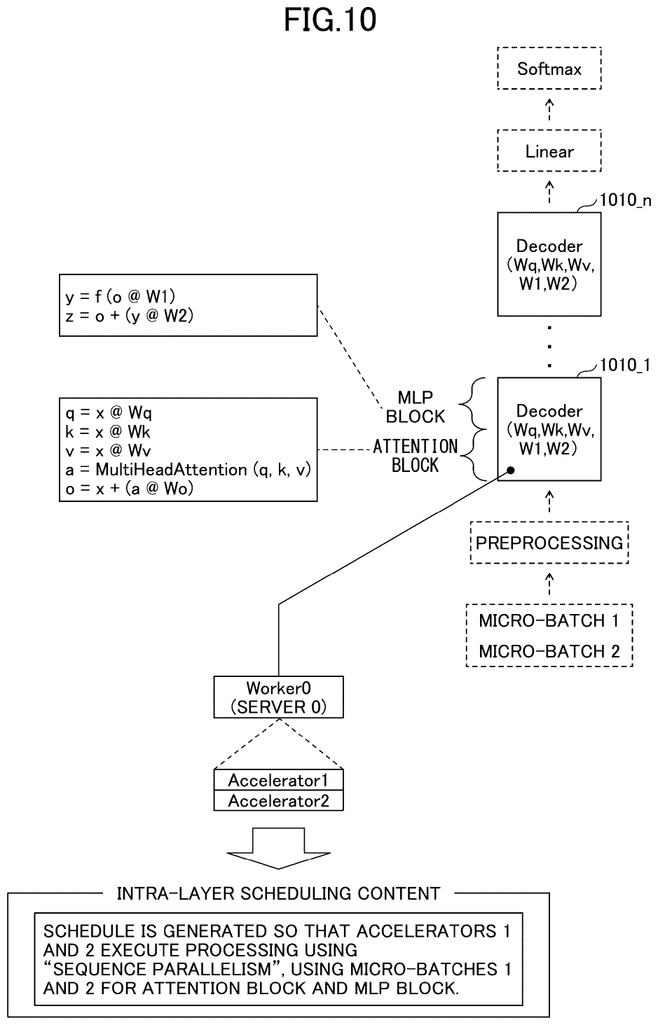

FIG. 10 is a diagram illustrating an outline of the scheduling by the information processing device according to the third embodiment. In FIG. 10, reference numerals 1010_1 to 1010_n indicate a plurality of decoders constituting the Transformer. The example of FIG. 10 indicates a state in which a worker whose name is “Worker0” is assigned to a training process in the decoder indicated by reference numeral 1010_1. In the example of FIG. 10, the worker is a single server device (Server 0) and includes two accelerators. The decoder indicated by reference numeral 1010_1 is divided into an attention block and an MLP block. When data based on Micro-batches 1 and 2 are input via the preprocessing unit as input data, the calculation executed in the attention block of the decoder indicated by reference numeral 1010_1 is as described in the second embodiment above. Additionally, the calculation executed in the MLP block of the decoder indicated by reference numeral 1010_1 is also as described in the second embodiment above.

In the second embodiment, the scheduling unit 302 generates a schedule so that Accelerators 1 and 2 execute, using sequence parallelism, calculations in the attention block and in the MLP block, using data based on Micro-batches 1 and 2 as input data.

### (2) Scheduling by Scheduling Unit of Comparative Example

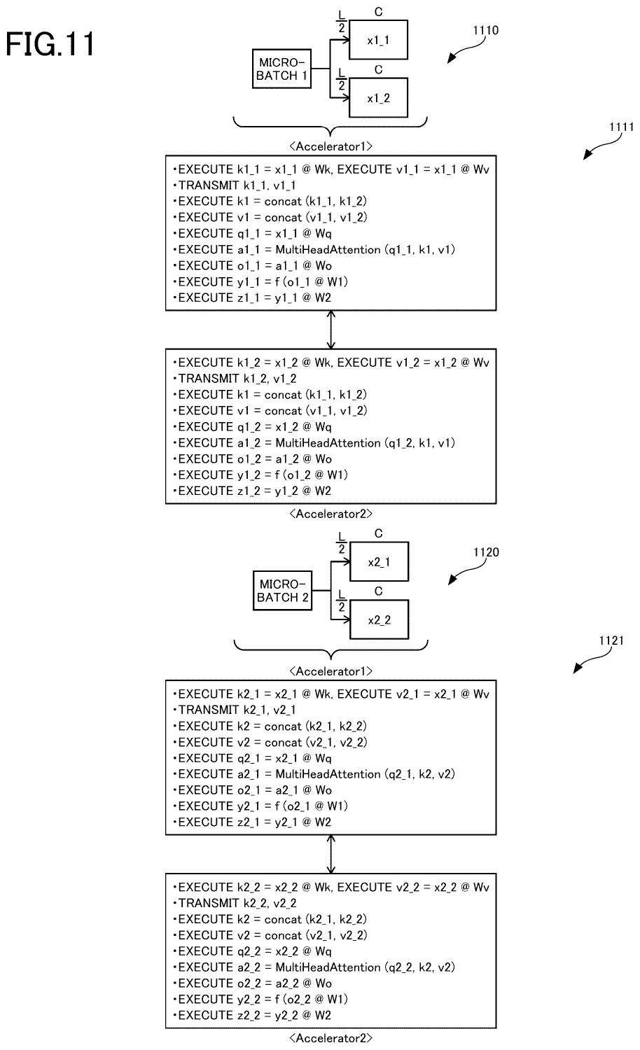

Next, a schedule generated by a scheduling unit of a comparative example will be described based on the outline of the intra-layer scheduling illustrated in FIG. 10. The scheduling unit of the comparative example is a generic name for a general scheduling unit that generates a schedule so as to execute forward calculations using sequence parallelism. To clarify the difference between the schedule generated by the scheduling unit 302 of the information processing device 120 and a general schedule, the scheduling of the comparative example will be described first. FIG. 11 is a second diagram illustrating a specific example of the scheduling by the scheduling unit of the comparative example.

As indicated by reference numeral 1110, in order to enable sequence parallelism, the scheduling unit of the comparative example partitions the data x1 (L×C matrix) based on Micro-batch 1 in accordance with the number of accelerators (here, the number of partitions=2). With this, the scheduling unit 302 of the comparative example generates x1_1 and x1_2 ((L/2)×C matrices).

Subsequently, as indicated by reference numeral 1111, the scheduling unit of the comparative example assigns the processing in the attention block to Accelerators 1 and 2. Example of reference numeral 1111 indicates a state in which

$$k 1 \_ 1 = x {1}_{-} 1 @ W k , v 1 \_ 1 = x {1}_{-} 1 @ W v ,$$

are assigned to Accelerator 1, and

$$k 1 \_ 2 = x {1}_{-} 2 @ Wk , v 1 \_ 2 = x {1}_{-} 2 @ Wk ,$$

are assigned to Accelerator 2. Here, k1_1, k1_2, v1_1, v1_2 are (L/2)×C matrices, and Wk and Wv are C×C matrices.

Additionally, the example of reference numeral 1111 indicates a state in which, after a process of sending and receiving, between accelerators, k1_1, v1_1 and k1_2, v1_2 calculated in Accelerators 1 and 2,

$$k 1 = contact ( k {1}_{-} 1 , k {1}_{-} 2 ) , v 1 = contact ( {v1}_{-} 1 , v {1}_{-} 2 ) ,$$

are assigned to Accelerators 1 and 2. Here, k1 and v1 are L×C matrices.

Additionally, the example of reference numeral 1111 indicates a state in which

$$q {1}_{-} 1 = x 1 \_ 1 @ W q , a {1}_{-} 1 = MultiHeadAttention ( q {1}_{-} 1 , k 1 , v 1 ) , o 1 \_ 1 = x {1}_{-} 1 + ( a 1 \_ 1 @ Wo ) ,$$

are assigned to Accelerators 1, and

$$q {1}_{-} 2 = x 1 \_ 2 @ W q , a {1}_{-} 2 = MultiHeadAttention ( q {1}_{-} 2 , k 1 , v 1 ) , o 1 \_ 2 = x {1}_{-} 2 + ( a 1 \_ 2 @ Wo ) ,$$

are assigned to Accelerator 2. Here, q1_2, a1_2, and o1_2 are (L/2)×C matrices, and Wq and Wo are C×C matrices.

Additionally, as indicated by reference numeral 1111, the scheduling unit of the comparative example assigns the processing in the MLP block to Accelerators 1 and 2. The example indicated by reference numeral 1111 indicates a state in which

$$y {1}_{-} 1 = f ( o {1}_{-} 1 @ W 1 ) , z {1}_{-} 1 = o {1}_{-} 1 + ( y 1 \_ 1 @ W 2 ) ,$$

are assigned to Accelerator 1, and

$$y {1}_{-} 2 = f ( o {1}_{-} 2 @ W 1 ) , z 1 \_ 2 = o {1}_{-} 2 + ( y {1}_{-} 2 @ W 2 ) ,$$

are assigned to Accelerator 2.

Subsequently, the scheduling unit of the comparative example similarly performs scheduling for Micro-batch 2.

As indicated by reference numeral 1120, in order to enable sequence parallelism, the scheduling unit 302 of the comparative example partitions the data x2 (L×C matrix) based on Micro-batch 2 in accordance with the number of accelerators (here, the number of partitions=2). With this, the scheduling unit 302 of the comparison example generates x2_1, x2_2 ((L/2)×C matrix).

Subsequently, as indicated by reference numeral 1121, the scheduling unit of the comparison example assigns the processing in the attention block to Accelerators 1 and 2. Example of reference numeral 1121 indicates a state in which

$$k {2}_{-} 1 = x {2}_{-} 1 @ Wk , v {2}_{-} 1 = {x2}_{-} 1 @ Wv ,$$

are assigned to Accelerator 1, and

$$k {2}_{-} 2 = {x2}_{-} 2 @ Wk , v {2}_{-} 2 = {x2}_{-} 2 @ Wv ,$$

are assigned to Accelerator 2. Here, k2_1, k2_2, v2_1 and v2_2 are (L/2)×C matrices, and Wk and Wv are C×C matrices.

Additionally, the example of reference numeral 1121 indicates a state in which after a process of sending and receiving, between accelerators, k2_1, v2_1 and k2_2, v2_2 calculated in Accelerators 1 and 2,

$$k2 = concat ( k {2}_{-} 1 , k {2}_{-} 2 ) , v2 = concat ( v {2}_{-} 1 , v {2}_{-} 2 ) ,$$

are assigned to Accelerators 1 and 2. Here, k2 and v2 are L×C matrices.

Additionally, the example of reference numeral 1121 indicate a state in which

$$q 2 \_ 1 = x 2 \_ 1 @ Wq ,$$

$$a 2 \_ 1 = MultiHeadAttention ( q 2 \_ 1 , k 2 , v 2 ) ,$$

$$o 2 \_ 1 = x 2 \_ 1 + ( a 2 \_ 1 @ Wo ) ,$$

are assigned to Accelerator 1, and

$$q 2 \_ 2 = x2\_ 2 @ Wq ,$$

$$a 2 \_ 2 = MultiHeadAttention ( q 2 \_ 2 , k 2 , v 2 ) ,$$

$$o 2 \_ 2 = x 2 \_ 2 + ( a 2 \_ 2 @ Wo ) ,$$

are assigned to Accelerator 2. Here, q2_2, a2_2, o2_2, Wq, and Wo are (L/2)×C matrices.

Additionally, as indicated by reference numeral 1121, the scheduling unit of the comparative example assigns the processing in the MLP block to Accelerators 1 and 2. The example of reference numeral 1121 indicates a state in which

$$y 2 \_ 1 = f ( o 2 \_ 1 @ W 1 ) ,$$

$$z 2 \_ 1 = o 2 \_ 1 + ( y 2 \_ 1 @ W 2 ) ,$$

are assigned to Accelerator 1, and

$$y 2 \_ 2 = f ( o 2 \_ 2 @ W 1 ) ,$$

$$z 2 \_ 2 = o 2 \_ 2 + ( y 2 \_ 2 @ W 2 ) ,$$

are assigned to Accelerator 2.

### (3) Scheduling by Scheduling Unit 302

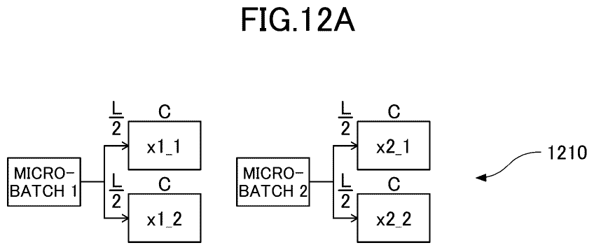

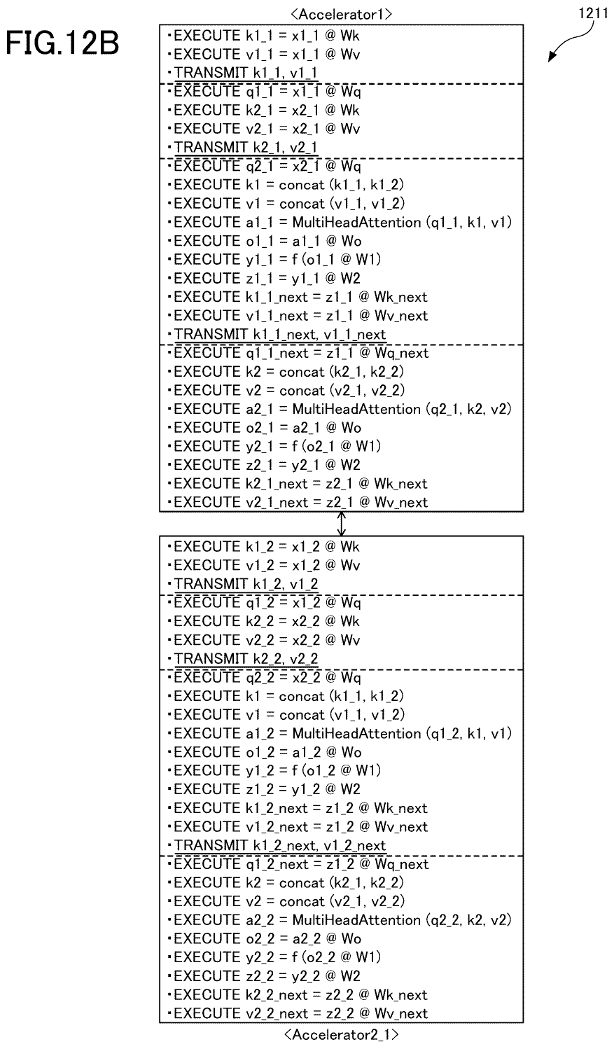

Next, a schedule generated by the scheduling unit 302 of the information processing device 120 according to the third embodiment will be described. FIGS. 12A and 12B are first and second diagrams illustrating a specific example of scheduling by the scheduling unit of the information processing device according to the third embodiment.

As illustrated by reference numeral 1210 in FIG. 12A, in order to enable sequence parallelism, the scheduling unit 302 partitions the data x1 (L×C matrix) based on Micro-batch 1 in accordance with the number of accelerators (here, the number of partitions=2). With this, the scheduling unit 302 generates x1_1 and x1_2 ((L/2)×C matrix). At this time, the scheduling unit 302 schedules the processing for the data based on the two micro-batches (Micro-batches 1 and 2) as a group. Therefore, the scheduling unit 302 partitions the data x2 (L×C matrix) based on Micro-batch 2 in accordance with the number of accelerators (here, the number of partitions=2) to generate x2_1 and x2_2 ((L/2)×C matrix).

Subsequently, as indicated by reference numeral 1211 in FIG. 12B, the scheduling unit 302 assigns the processing in the attention block. Example of reference numeral 1211 indicates a state in which

$$k 1 \_ 1 = x 1 \_ 1 @ Wk ,$$

$$v 1 \_ 1 = x 1 \_ 1 @ Wv ,$$

$$transmit k 1 \_ 1 , v 1 \_ 1 to Accelerator 2 ,$$

are assigned to Accelerator 1, and

$$k 1 \_ 2 = x 1 \_ 2 @ Wk ,$$

$$v 1 \_ 2 = x 1 \_ 2 @ Wv ,$$

$$transmit k 1 \_ 2 and v 1 \_ 2 to Accelerator 1 ,$$

are assigned to Accelerator 2. Here, k1_1, k1_2, v1_1 and v1_2 are (L/2)×C matrices. k1_1 and k1_2 together are called k1 (L×C matrix), and v1_1 and v1_2 together are called v1 (L×C matrix).

Additionally, the example of reference numeral 1211 indicates a state in which

$$q 1 \_ 1 = x 1 \_ 1 @ Wq ,$$

$$k 2 \_ 1 = x 2 \_ 1 @ Wk ,$$

$$v 2 \_ 1 = x 2 \_ 1 @ Wv ,$$

$$transmit k 2 \_ 1 , v 2 \_ 1 to Accelerator 2 ,$$

are assigned to Accelerator 1,

$$q 1 \_ 2 = x 1 \_ 2 @ Wq ,$$

$$k 2 \_ 2 = x 2 \_ 2 @ Wk ,$$

$$v 2 \_ 2 = x 2 \_ 2 @ Wv ,$$

$$transmit k 2 \_ 2 , v 2 \_ 2 to Accelerator 1 ,$$

are assigned to Accelerator 2. Here, q1_1, k2_1, k2_2, v2_1 and v2_2 are (L/2)×C matrices. k2_1 and k2_2 together are called k2 (L×C matrix), and v2_1 and v2_2 together are called v2 (L×C matrix).

By assigning the processing in such a way, according to the scheduling unit 302, for example,
a process of communicating, between Accelerator 1 and Accelerator 2, k1_1 and v1_1, and k1_2 and v1_2, calculated by using the data based on the previous micro-batch as input data, and
a process of calculating q1_1, k2_1, and v2_1, or a process of calculating q1_2, k2_2, and v2_2, using the data based on the next micro-batch as input data,
   can be performed in parallel.

Additionally, the example of reference numeral 1211 indicates a state in which

$$q 2 \_ 1 = x 2 \_ 1 @ Wq ,$$

$$k 1 = concat ( k 1 \_ 1 , k 1 \_ 2 ) ,$$

$$v 1 = concat ( v 1 \_ 1 , v 1 \_ 2 ) ,$$

$$a 1 \_ 1 = MultiHeadAttention ( q 1 \_ 1 , k 1 , v 1 ) ,$$

$$o 1 \_ 1 = x 1 \_ 1 + ( a 1 \_ 1 @ Wo ,$$

$$k 1 \_ 1 \_next = z 1 \_ 1 @ Wk\_next ,$$

$$v 1 \_ 1 \_next = z 1 \_ 1 @ Wv\_next ,$$

$$transmit k 1 \_ 1 \_next , v 1 \_ 1 \_next to Accelerator 2 ,$$

are assigned to Accelerator 1, as processing of the attention block,

$$q 2 \_ 2 = x 2 \_ 2 @ Wq ,$$

$$k 1 = concat ( k 1 \_ 1 , k 1 \_ 2 ) ,$$

$$v 1 = concat ( v 1 \_ 1 , v 1 \_ 2 ) ,$$

$$a 1 \_ 2 = MultiHeadAttention ( q 1 \_ 2 , k 1 , v 1 ) ,$$

$$o 1 \_ 2 = x 1 \_ 2 + ( a 1 \_ 2 @ Wo ,$$

$$k 1 \_ 2 \_next = z 1 \_ 2 @ Wk\_next ,$$

$$v 1 \_ 2 \_next = z 1 \_ 2 @ Wv\_next ,$$

$$transmit k 1 \_ 2 \_next , v 1 \_ 2 \_next to Accelerator 1 ,$$

are assigned to Accelerator 2 as processing of the attention block,

$$y 1 \_ 1 = f ( o 1 \_ 1 @ W 1 ) ,$$

$$z 1 \_ 1 = o 1 \_ 1 + ( y 1 \_ 1 @ W 2 ) ,$$

are assigned to Accelerator 2 as processing of the MLP block.

$$y 1 \_ 2 = f ( o 1 \_ 2 @ W 1 ) ,$$

$$z 1 \_ 2 = o 1 \_ 2 + ( y 1 \_ 2 @ W 2 ) ,$$

are assigned to Accelerator 1 as processing of the MLP block. Here, q2_1, q2_2, a1_1, a1_2, o1_1, and o1_2 are (L/2)×C matrices.

By assigning the processing in such a way, according to the scheduling unit 302, for example,
a process of communicating, between the Accelerator 1 and the Accelerator 2, k2_1 and v2_1, and k2_2 and v2_2, calculated by using data based on the next micro-batch as input data,
a process of calculations up to o1_1 or o1_2 by using data based on the previous micro-batch as input data, and
a process of calculating k1_1_next, v1_1_next, k1_2_next, and v1_2_next by using data based on the next micro-batch as input data,
   can be performed in parallel.

Additionally, by assigning the processing in such a way, according to the scheduling unit 302, for example,
a process of communicating, between the Accelerator 1 and the Accelerator 2, k2_1 and v2_1, and k2_2 and v2_2, calculated by using data based on the next micro-batch as input data, and
a process of calculating y1_1 and z1_1, or a process of calculating y1_2 and z1_2, using data based on the previous micro-batch as input data, can be performed in parallel.

Additionally, the example of reference numeral 1211 indicates a state in which

$$q 1 \_ 1 \_next = z 1 \_ 1 @ Wq\_next ,$$

$$k 2 = concat ( k 2 \_ 1 , k 2 \_ 2 ) ,$$

$$v 2 = concat ( v 2 \_ 1 , v 2 \_ 2 ) ,$$

$$a 2 \_ 1 = MultiHeadAttention ( q 2 \_ 1 , k 2 , v 2 ) ,$$

$$o 2 \_ 1 = x 2 \_ 1 + ( a 2 \_ 1 @ Wo ) ,$$

$$k 2 \_ 1 \_next = z 2 \_ 1 @ Wk\_next ,$$

$$v 2 \_ 1 \_next = z 2 \_ 1 @ Wv\_next ,$$

are assigned to Accelerator 1 as the processing of the attention block,

$$q 1 \_ 2 \_next = z 1 \_ 2 @ Wq\_next ,$$

$$k 2 = concat ( k 2 \_ 1 , k 2 \_ 2 ) ,$$

$$v 2 = concat ( v 2 \_ 1 , v 2 \_ 2 ) ,$$

$$a 2 \_ 2 = MultiHeadAttention ( q 2 \_ 2 , k 2 , v 2 ) ,$$

$$o 2 \_ 2 = x 2 \_ 2 + ( a 2 \_ 2 @ Wo ) ,$$

$$k 2 \_ 2 \_next = z 2 \_ 2 @ Wk\_next ,$$

$$v 2 \_ 2 \_next = z 2 \_ 2 @ Wv\_next ,$$

are assigned to Accelerator 2 as the processing of the attention block,

$$y {2}_{-} 1 = f ( o 2\_ 1 @ W 1 ) , z 2 \_ 1 = o {2}_{-} 1 + ( y {2}_{-} 1 @ W 2 ) ,$$

are assigned to Accelerator 1 as the processing of the MLP block, and

$$y {2}_{-} 2 = f ( o 2\_ 2 @ W 1 ) , z 2 \_ 2 = o {2}_{-} 2 + ( y {2}_{-} 2 @ W 2 ) ,$$

are assigned to Accelerator 2 as the processing of the MLP block. Here, q1_1_next, q1_2_next, a2_1, a2_2, o2_1, and o2_2 are (L/2)×C matrices.

By assigning the processing in such a way, according to the scheduling unit 302, for example,
a process of communicating, between the Accelerator 1 and the Accelerator 2, k1_1_next and v1_1_next, and k1_2_next and v1_2_next, calculated by using data based on the next micro-batch as input data, and
a process of calculating q1_1_next to v2_1_next, or a process of calculating q1_2_next to v2_2_next, using data based on the second subsequent micro-batch as input data,
   can be performed in parallel.

Additionally, by assigning the processing in such a way, according to the scheduling unit 302, for example,
a process of communicating, between the Accelerator 1 and the Accelerator 2, k1_1_next and v1_1_next, and k1_2_next and v1_2_next, calculated by using data based on the next micro-batch as input data, and
a process of calculating y2_1 and z2_1, or a process of calculating y2_2 and z2_2, using data based on the next micro-batch as input data,
   can be performed in parallel.

### Summary

As is clear from the above description, in the information processing device 120 according to the third embodiment, in the scheduling for the training process performed using sequence parallelism in the decoder of the Transformer,
the processing is assigned to a plurality of accelerators used for sequence parallelism so as to execute, in parallel, using the data based on two micro-batches adjacent in the processing order as a set of input data, the communication processing, between accelerators, of a result of executing the computational processing for the first input data in the attention block and the computational processing for the second input data in the attention block,
the processing is assigned to a plurality of accelerators used for sequence parallelism so as to execute, in parallel, using the data based on two micro-batches adjacent in the processing order as a set of input data, the communication processing, between accelerators, of a result of executing the computational processing for the second input data in the attention block, the computational processing for the third input data in the attention block, and the computational processing for the first input data in the MLP block,
the processing is assigned to a plurality of accelerators used for sequence parallelism so as to execute, in parallel, using data based on two micro-batches adjacent in the processing order as a set of input data, communication processing, between accelerators, of a result of executing the computational processing for the third input data in the attention block, and the computational processing for the fourth input data in the attention block and computational processing for the second input data in the MLP block.

Additionally, when the server device according to the third embodiment performs the training process using sequence parallelism in the decoder of the Transformer, the server device is configured to:
execute, in parallel, using the data based on two micro-batches adjacent in the processing order as a set of input data, the communication processing, between the accelerators, a result of executing the computational processing for the first input data in the attention block, and the computational processing for the second input data in the attention block;
execute, in parallel, using the data based on two micro-batches as a set of input data, the communication processing, between the accelerators, of a result of executing the computational processing for the second input data in the attention block, and the computational processing for the third input data in the attention block and the computational processing for the first input data in the MLP block; and
execute, in parallel, using the data based on two micro-batches as a set of input data, the communication processing, between the accelerators, of a result of executing the computational processing for the third input data in the attention block, and the computational processing for the fourth input data in the attention block and the computational processing for the second input data in the MLP block.

With this, according to the third embodiment, in comparison with the case where after the computational processing of the previous input data is executed and the communication processing between accelerators is completed, the computational processing of the next input data is executed, the execution speed when the training process is performed using sequence parallelism can be improved.

Here, in the present embodiment, the case where the training process is performed by using sequence parallelism, using the data based on a plurality of micro-batches as input data in the decoder of the Transformer has been described. However, if the Transformer includes an encoder, the training process using by sequence parallelism may be performed by substantially the same method in the encoder.

### Fourth Embodiment

In the second embodiment above, the scheduling when the training process is performed using tensor parallelism, using the data based on a plurality of micro-batches as input data in the decoder of the Transformer has been described. Additionally, in the third embodiment, the scheduling when the training process is performed using sequence parallelism, using the data based on a plurality of micro-batches as input data in the decoder of the Transformer has been described.

In a fourth embodiment, scheduling when a training process is performed using tensor parallelism and sequence parallelism, using data based on a plurality of micro-batches as input data in the decoder of the Transformer will be described. Here, the fourth embodiment will be described mainly on differences from the second and third embodiments described above.

### Specific Example of Scheduling

### (1) Outline of Intra-Layer Scheduling

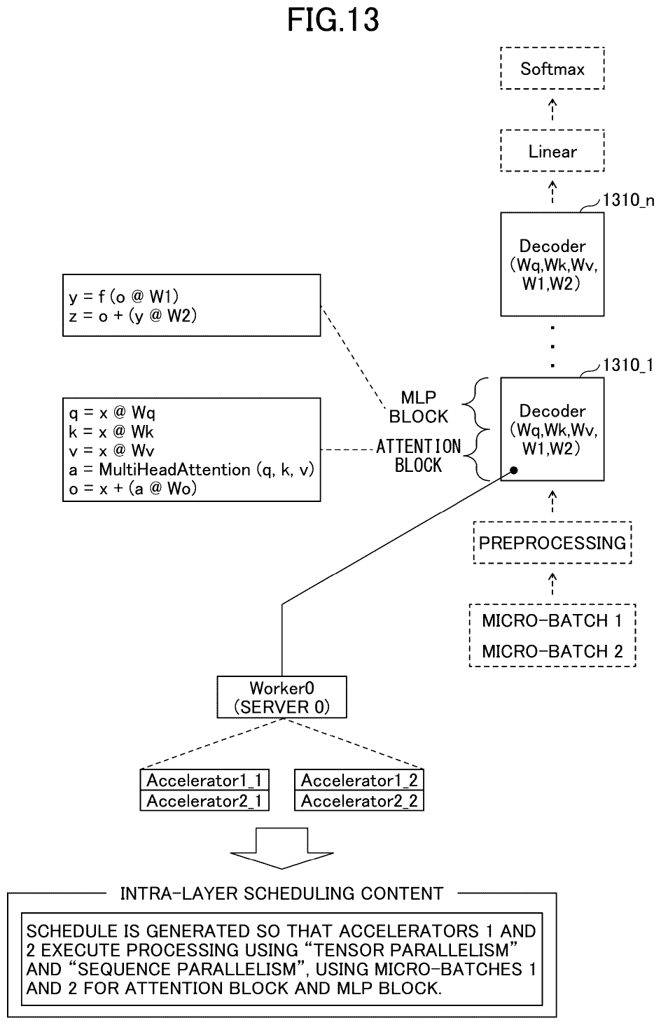

FIG. 13 is a diagram illustrating an outline of scheduling by an information processing device according to the fourth embodiment. In FIG. 13, reference numerals 1310_1 to 1310_n indicate a plurality of decoders constituting the Transformer. The example of FIG. 13 indicates a state in which a worker whose name is “Worker0” is assigned to the training process in the decoder indicated by reference numeral 1310_1. In the example of FIG. 13, the worker is a single server device (Server 0) and includes four accelerators. The decoder indicated by reference numeral 1310_1 is divided into an attention block and an MLP block. When the data based on Micro-batches 1 and 2 are input via the preprocessing unit as input data, the calculation executed in the attention block of the decoder indicated by reference numeral 1310_1 is as described in the second and third embodiments. The calculation executed in the MLP block of the decoder indicated by reference numeral 1310_1 is also as described in the second and third embodiments.

In the fourth embodiment, the scheduling unit 302 generates a schedule, using the data based on Micro-batches 1 and 2 as input data, so that the Accelerator 1_1 to 2_2 execute the respective calculations of the attention block and the MLP block, using tensor parallelism and sequence parallelism.

### (2) Scheduling by Scheduling Unit 302

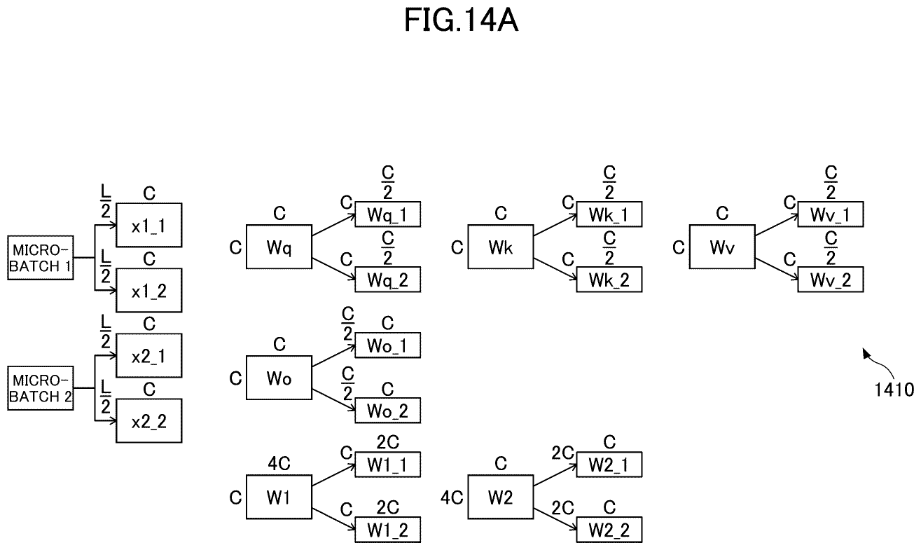

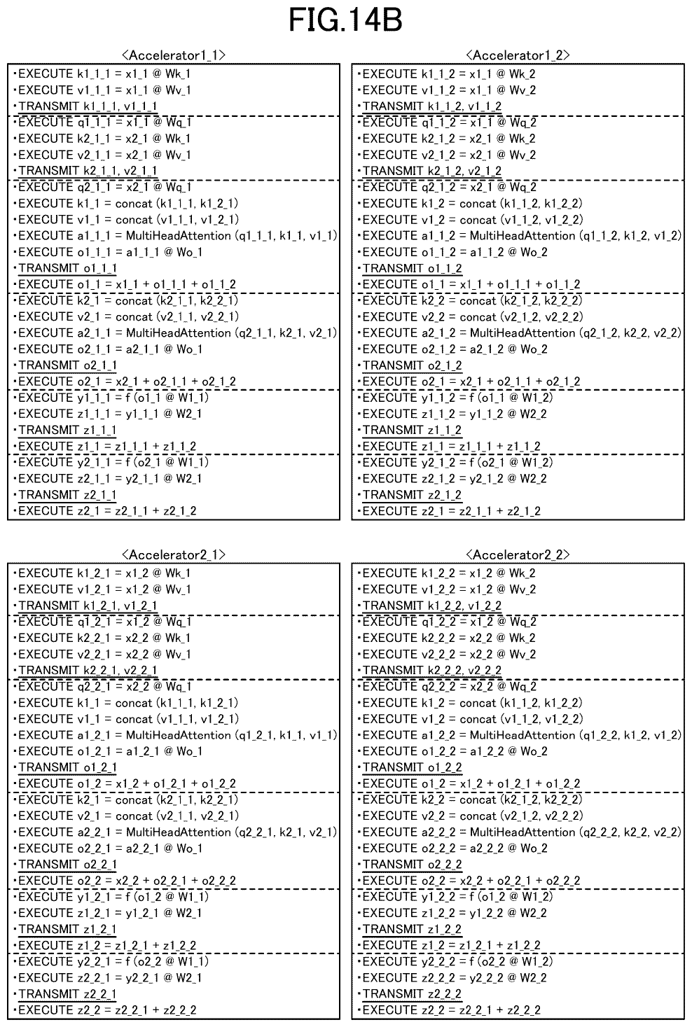

Next, a schedule generated by the scheduling unit 302 of the information processing device 120 according to the fourth embodiment will be described. FIGS. 14A and 14B are first and second diagrams illustrating a specific example of the scheduling by the scheduling unit of the information processing device according to the fourth embodiment.

As indicated by reference numeral 1410 in FIG. 14A, in order to enable tensor parallelism and sequence parallelism, the scheduling unit 302 partitions the data x1 (L×C matrix) based on Micro-batch 1 in accordance with the number of accelerators (here, the number of partitions=2). With this, the scheduling unit 302 generates x1_1 and x1_2 ((L/2)×C matrices). At this time, the scheduling unit 302 schedules the processing for the data based on the two micro-batches (Micro-batches 1 and 2) as a group. Thus, the scheduling unit 302 partitions the data x2 (L×C matrix) based on Micro-batch 2 in accordance with the number of accelerators (here, the number of partitions=2) and generates x2_1 and, x2_2 ((L/2)×C matrices).

Subsequently, as indicated by reference numeral 1411 in FIG. 14B, the scheduling unit 302 assigns the processing in the attention block. Example of reference numeral 1411 indicates a state in which

$$k {1}_{-} {1}_{-} 1 = x {1}_{-} 1 @ W {k}_{-} 1 , v {1}_{-} {1}_{-} 1 = x {1}_{-} 1 @ W {v}_{-} 1 , transmit k {1}_{-} {1}_{-} 1 , v {1}_{-} {1}_{-} 1 to Accelerator 2 \_ 1 ,$$

are assigned to Accelerator 1_1,

$$k {1}_{-} {2}_{-} 1 = x {1}_{-} 2 @ W {k}_{-} 1 , v {1}_{-} {2}_{-} 1 = x {1}_{-} 2 @ W {v}_{-} 1 , transmit k {1}_{-} {2}_{-} 1 , v {1}_{-} {2}_{-} 1 to Accelerator 1 \_ 1 ,$$

are assigned to Accelerator 2_1,

$$k {1}_{-} {1}_{-} 2 = x {1}_{-} 1 @ W {k}_{-} 2 , v {1}_{-} {1}_{-} 2 = x {1}_{-} 1 @ W {v}_{-} 2 , transmit k {1}_{-} {1}_{-} 2 , v {1}_{-} {1}_{-} 2 to Accelerator 2 \_ 2 ,$$

are assigned to Accelerator 1_2,

$$k {1}_{-} {2}_{-} 2 = x {1}_{-} 2 @ {Wk}_{-} 2 , v {1}_{-} {2}_{-} 2 = x {1}_{-} 2 @ {Wv}_{-} 2 , transmit k {1}_{-} {2}_{-} 2 , v {1}_{-} {2}_{-} 2 to Accelerator 1 \_ 2 ,$$

are assigned to Accelerator 2_2. Here, k1_1_1, k1_2_1, k1_1_2, k1_2_2, v1_1_1, v1_2_1, v1_1_2, and v1_2_2 are (L/2)×(C/2) matrices. k1_1_1 and k1_2_1 together are called k1_1 (L×(C/2) matrix), and v1_1_1 and v1_2_1 together are called v1_1 (L×(C/2) matrix). k1_1_2 and k1_2_2 together are called k1_2 (L×(C/2) matrix), and v1_1_2 and v1_2_2 together are called v1_2 (L×(C/2) matrix).

Additionally, the example of reference numeral 1411 indicates a state in which

$$q {1}_{-} {1}_{-} 1 = x {1}_{-} 1 @ Wq \_ 1 , \\ k {2}_{-} {1}_{-} 1 = x {2}_{-} 1 @ {Wk}_{-} 1 , v {2}_{-} {1}_{-} 1 = x {1}_{-} 1 @ {Wv}_{-} 1 , transmit k {2}_{-} {1}_{-} 1 , v {2}_{-} {1}_{-} 1 to Accelerator 2 \_ 1 ,$$

are assigned to the Accelerator 1_1,

$$q {1}_{-} {2}_{-} 1 = x {1}_{-} 2 @ Wq \_ 1 , \\ k {2}_{-} {2}_{-} 1 = x {2}_{-} 2 @ {Wk}_{-} 1 , v {2}_{-} {2}_{-} 1 = x {2}_{-} 2 @ {Wv}_{-} 1 , transmit k {2}_{-} {2}_{-} 1 , v {2}_{-} {2}_{-} 1 to Accelerator 1 \_ 1 ,$$

are assigned to Accelerator 2_1,

$$q {1}_{-} {1}_{-} 2 = x {1}_{-} 1 @ Wq \_ 2 , \\ k {2}_{-} {1}_{-} 2 = x {2}_{-} 1 @ {Wk}_{-} 2 , v {2}_{-} {1}_{-} 2 = x {2}_{-} 1 @ {Wv}_{-} 2 , transmit k {2}_{-} {1}_{-} 2 , v {2}_{-} {1}_{-} 2 to Accelerator 2 \_ 2 ,$$

are assigned to Accelerator 1_2, and

$$q {1}_{-} {2}_{-} 2 = x {1}_{-} 2 @ Wq \_ 2 , \\ k {2}_{-} {2}_{-} 2 = x {2}_{-} 2 @ {Wk}_{-} 2 , v {2}_{-} {2}_{-} 2 = x {2}_{-} 2 @ {Wv}_{-} 2 , transmit k {2}_{-} {2}_{-} 2 , v {2}_{-} {2}_{-} 2 to Accelerator 1 \_ 2 ,$$

are assigned to Accelerator 2_2. Here, q1_1_1, q1_2_1, q1_1_2, q1_2_2, k2_1_1, k2_2_1, k2_1_2, k2_2_2, v2_1_1, v2_2_1, v2_1_2 and v2_2_2 are (L/2)×(C/2) matrices. k2_1_1 and k2_2_1 together are called k2_1 (L×(C/2) matrix), and k2_1_2 and k2_2_2 together are called k2_2 (L×(C/2) matrix). v2_1_1 and v2_2_1 together are called v2_1 (L×(C/2) matrix), and v2_1_2 and v2_2_2 together are called v2_2 (L×(C/2) matrix).

By assigning the processing in such a way, according to the scheduling unit 302, for example,
a process of communicating, between Accelerator 1_1 and Accelerator 2_1, k1_1_1 and v1_1_1, and k1_2_1 and v1_2_1, calculated using data based on the previous micro-batch as input data, and
a process of calculating k2_1_1 and v2_1_1, or a process of calculating k2_2_1 and v2_2_1, using data based on the next micro-batch as input data,
   can be performed in parallel. Additionally, according to the scheduling unit 302, for example,
a process of communicating, between the Accelerator 1_2 and Accelerator 2_2, k1_1_2 and v1_1_2, and k1_2_2 and v1_2_2, calculated by using data based on the previous micro-batch as input data, and
a process of calculating k2_1_2 and v2_1_2 or a process of calculating k2_2_2 and v2_2_2, using data based on the next micro-batch as input data,
   can be performed in parallel.

Additionally, the example of reference numeral 1411 indicates a state in which

$$q {2}_{-} {1}_{-} 1 = x {2}_{-} 1 @ {Wq}_{-} 1 , k {1}_{-} 1 = concat ( k {1}_{-} {1}_{-} 1 , k {1}_{-} {2}_{-} 1 ) , v {1}_{-} 1 = concat ( v {1}_{-} {1}_{-} 1 , v {1}_{-} {2}_{-} 1 ) , a {1}_{-} {1}_{-} 1 = MultiHeadAttention ( q {1}_{-} {1}_{-} 1 , k {1}_{-} 1 , v {1}_{-} 1 ) , {o 1}_{-} {1}_{-} 1 = a {1}_{-} {1}_{-} 1 @ W {0}_{-} 1 , transmit {01}_{-} {1}_{-} 1 to Accelerator 1 \_ 2 , \\ o 1 \_ 1 = x 1 \_ 1 + o {1}_{-} {1}_{-} 1 + o {1}_{-} {1}_{-} 2 ,$$

are assigned to Accelerator 1_1 as the processing of the attention block,

$$q {2}_{-} {2}_{-} 1 = x {2}_{-} 2 @ {Wq}_{-} 1 , a {1}_{-} {2}_{-} 1 = M u ltiHeadAttention ( q {1}_{-} {2}_{-} 1 , k {1}_{-} 1 , v {1}_{-} 1 ) , o {1}_{-} {2}_{-} 1 = a {1}_{-} {2}_{-} 1 @ {Wo}_{-} 1 , \\ transmit {01}_{-} {2}_{-} 1 to Accelerator 2 \_ 2 , \\ o 1 \_ 2 = x {1}_{-} 2 + o {1}_{-} {2}_{-} 1 + o {1}_{-} {2}_{-} 2 ,$$

are assigned to Accelerator 2_1 as the processing of the attention block,

$$q {2}_{-} {1}_{-} 2 = x {2}_{-} 1 @ {Wq}_{-} 2 , k {1}_{-} 2 = concat ( k {1}_{-} {1}_{-} 2 , k {1}_{-} {2}_{-} 2 ) , v {1}_{-} 2 = concat ( v {1}_{-} {1}_{-} 2 , v {1}_{-} {2}_{-} 2 ) , a {1}_{-} {1}_{-} 2 = MultiHeadAttention ( q {1}_{-} {1}_{-} 2 , k {1}_{-} 2 , v {1}_{-} 2 ) , {o 1}_{-} {1}_{-} 2 = a {1}_{-} {1}_{-} 2 @ W {0}_{-} 2 , transmit {01}_{-} {1}_{-} 2 to Accelerator 1 \_ 1 , \\ o 1 \_ 1 = x 1 \_ 1 + o {1}_{-} {1}_{-} 1 + o {1}_{-} {1}_{-} 2 ,$$

are assigned to Accelerator 1_2 as the processing of the attention block, and

$$q2\_ 2 \_ 2 = x2\_ 2 @ {Wq}_{-} 2 , k 1 \_ 2 = ( k1\_ 1 \_ 2 , k 1 \_ 2 \_ 2 ) , v 1 \_ 2 = ( v1\_ 1 \_ 2 , v 1 \_ 2 \_ 2 ) , a 1 \_ 2 \_ 2 = M u ltiHeadAttention ( q 1 \_ 2 \_ 2 , k 1 \_ 2 , v 1 \_ 2 ) , o 1 \_ 2 \_ 2 = a 1 \_ 2 \_ 2 @ Wo\_ 2 , transmit o 1 \_ 2 \_ 2 to Accelerator 2 \_ 1 , o 1 \_ 2 = x 1 \_ 2 + o 1 \_ 2 \_ 1 + o 1 \_ 2 \_ 2 ,$$

are assigned to Accelerator 2_2 as the processing of the attention block. Here, q2_1_1, q2_2_1, q2_1_2, and q2_2_2 are (L/2)×(C/2) matrices. a1_1_1, a1_2_1, a1_1_2, and a1_2_2 are (L/2)×(C/2) matrices. o1_1_1, o1_2_1, o1_1_2, and o1_2_2 are (L/2)×C matrices. o1_1 and o1_2 are (L/2)×C matrices.

By assigning the processing in such a way, according to the scheduling unit 302, for example,
a process of communicating, between Accelerator 1_1 and Accelerator 2_1, k2_1_1 and v2_1_1, and k2_2_1 and v2_2_1, calculated by using data based on the next micro-batch as input data, and
a process of calculating a1_1_1 and o1_1_1 or a process of calculating a1_2_1 and o1_2_1, using data based on the previous micro-batch as input data, can be performed in parallel. Additionally, according to the scheduling unit 302, for example,
a process of communicating, between the Accelerator 1_2 and the Accelerator 2_2, k2_1_2 and v2_1_2, and k2_2_2 and v2_2_2, calculated using data based on the next micro-batch as input data, and
a process of calculating a1_1_2 and o1_1_2 or a process of calculating a1_2_2 and o1_2_2, using data based on the previous micro-batch as input data, can be performed in parallel.

Additionally, the example of reference

$$k2\_ 1 = concat ( k 2 \_ 1 \_ 1 , k 2 \_ 2 \_ 1 ) , v2\_ 1 = concat ( v2\_ 1 \_ 1 , v 2 \_ 2 \_ 1 ) , a2\_ 1 \_ 1 = MultiHeadAttention ( q2\_ 1 \_ 1 , k 2 \_ 1 , v 2 \_ 1 ) , o 2 \_ 1 \_ 1 = a 2 \_ 1 \_ 1 @ W {o}_{-} 1 , transmit o 2\_ 1 \_ 1 to Accelerator 1 \_ 2 , o 2 \_ 1 = x2\_ 1 + o 2 \_ 1 \_ 1 + 02 \_ 1 \_ 2 ,$$

are assigned to Accelerator 1_1 as the processing of the attention block,

$$k2\_ 1 = concat ( k 2 \_ 1 \_ 1 , k 2 \_ 2 \_ 1 ) , v2\_ 1 = concat ( v2\_ 1 \_ 1 , v 2 \_ 2 \_ 1 ) , a2\_ 2 \_ 1 = MultiHeadAttention ( q2\_ 2 \_ 1 , k 2 \_ 1 , v 2 \_ 1 ) , o 2 \_ 2 \_ 1 = a 2 \_ 2 \_ 1 @ W {o}_{-} 1 , transmit o 2\_ 2 \_ 1 to Accelerator 2 \_ 2 , o 2 \_ 2 = x2\_ 2 + o 2 \_ 2 \_ 2 + 02 \_ 2 \_ 2 ,$$

are assigned to Accelerator 2_1 as the processing of the attention block,

$$k2\_ 2 = concat ( k 2 \_ 1 \_ 2 , k 2 \_ 2 \_ 2 ) , v2\_ 2 = concat ( v2\_ 1 \_ 2 , v 2 \_ 2 \_ 2 ) , a2\_ 1 \_ 2 = MultiHeadAttention ( q2\_ 1 \_ 2 , k 2 \_ 2 , v 2 \_ 2 ) , o 2 \_ 1 \_ 2 = a 2 \_ 1 \_ 2 @ W {o}_{-} 2 , transmit o 2\_ 1 \_ 2 to Accelerator 1 \_ 1 , o 2 \_ 1 = x2\_ 1 + o 2 \_ 1 \_ 1 + 02 \_ 1 \_ 2 ,$$

are assigned to Accelerator 1_2 as the processing of the attention block, and

$$k2\_ 2 = concat ( k 2 \_ 1 \_ 2 , k 2 \_ 2 \_ 2 ) , v2\_ 2 = concat ( v2\_ 1 \_ 2 , v 2 \_ 2 \_ 2 ) , a2\_ 2 \_ 2 = MultiHeadAttention ( q2\_ 2 \_ 2 , k 2 \_ 2 , v 2 \_ 2 ) , o 2 \_ 2 \_ 2 = a 2 \_ 2 \_ 2 @ W {o}_{-} 2 , transmit o 2\_ 2 \_ 2 to Accelerator 2 \_ 1 , o 2 \_ 2 = x2\_ 2 + o 2 \_ 1 \_ 1 + 02 \_ 2 \_ 2 ,$$

are assigned to Accelerator 2_2 as the processing of the attention block. Here, a2_1_1, a2_2_1, a2_1_2, and a2_2_2 are (L/2)×(C/2) matrices. o2_1_1, o1_2_1, o2_1_2, and o2_2_2 are (L/2)×C matrices. o2_1 and o2_2 are (L/2)×C matrices.

By assigning the processing in such a way, according to the scheduling unit 302, for example,
a process of communicating, between accelerators (between Accelerator 1_1 and Accelerator 1_2), o1_1_1 and o1_1_2 calculated by using data based on the previous micro-batch as input data, and
a process of calculating a2_1_1 and o2_1_1 or a process of calculating a2_1_2 and o2_1_2, using data based on the next micro-batch as input data,
   can be performed in parallel. Additionally, according to the scheduling unit 302, for example,
a process of communicating, between accelerators (between Accelerator 2_1 and Accelerator 2_2), o1_2_1 and o1_2_2 calculated by using data based on the previous micro-batch as input data, and
a process of calculating a2_2_1 and o2_2_1 or a process of calculating a2_2_2 and o2_2_2, using data based on the next micro-batch as input data,
   can be performed in parallel.

Additionally, the example of reference numeral 1411 indicates a state in which

$$y {1}_{-} {1}_{-} 1 = f ( o {1}_{-} 1 @ W 1 \_ 1 ) , z {1}_{-} {1}_{-} 1 = o {1}_{-} 1 + ( y {1}_{-} {1}_{-} 1 @ W 2 \_ 1 ) , transmit z 1 \_ 1 \_ 1 to Accelerator 1 \_ 2 , z 1 \_ 1 = z {1}_{-} {1}_{-} 1 + z {1}_{-} {1}_{-} 2 ,$$

are assigned to Accelerator 1_1 as the processing of the MLP block,

$$y {1}_{-} {2}_{-} 1 = f ( o {1}_{-} 2 @ W 1 \_ 1 ) , z {1}_{-} {2}_{-} 1 = o {1}_{-} 2 + ( y {1}_{-} {2}_{-} 1 @ W 2 \_ 1 ) , transmit z 1 \_ 2 \_ 1 to Accelerator 2 \_ 2 , z 1 \_ 2 = z {1}_{-} {2}_{-} 1 + z {1}_{-} {2}_{-} 2 ,$$

are assigned to Accelerator 2_1 as the processing of the MLP block,

$$y 1 \_ 1 \_ 2 = f ( o 1 \_ 1 @ W 1 \_ 2 ) ,$$

$$z 1 \_ 1 \_ 2 = o 1 \_ 1 + ( y 1 \_ 1 \_ 2 @ W 2 \_ 2 ) ,$$

$$transmit z 1 \_ 1 \_ 2 to Accelerator 1 \_ 1.$$

$$z 1 \_ 1 = z 1 \_ 1 \_ 1 + z 1 \_ 1 \_ 2 ,$$

are assigned to Accelerator 1_2 as the processing of the MLP block, and

$$y 1 \_ 2 \_ 2 = f ( o 1 \_ 2 @ W 1 \_ 2 ,$$

$$z 1 \_ 2 \_ 2 = o 1 \_ 2 + ( y 1 \_ 2 \_ 2 @ W 2 \_ 2 ,$$

$$transmit z 1 \_ 2 \_ 2 to Accelerator 2 \_ 1 ,$$

$$z 1 \_ 2 = z 1 \_ 2 \_ 1 + z 1 \_ 2 \_ 2 ,$$

are assigned to Accelerator 2_2 as the processing of the MLP block. Here, z1_1 and z1_2 are (L/2)×C matrices.

By assigning the processing in such a way, according to the scheduling unit 302, for example,
a process of communicating, between the Accelerator 1_1 and Accelerator 1_2, o2_1_1 and o2_1_2 calculated using data based on the next micro-batch as input data, and
a process of calculating y1_1_1 and z1_1_1 or a process of calculating y1_1_2 and z1_1_2, using data based on the previous micro-batch as input data,
   can be performed in parallel. Additionally, according to the scheduling unit 302, for example,
a process of communicating, between Accelerator 1_1 and Accelerator 1_2, o2_2_1 and o2_2_2 calculated using data based on the next micro-batch as input data, and
a process of calculating y1_2_1 and z1_2_1 or a process of calculating y1_2_2 and z1_2_2, using data based on the previous micro-batch as input data,
   can be performed in parallel.

Additionally, the example of reference numeral 1411 indicates a state in which

$$y 2 \_ 1 \_ 1 = f ( o 2 \_ 1 @ W 1 \_ 1 ) ,$$

$$z 2 \_ 1 \_ 1 = o 2 \_ 1 + ( y 2 \_ 1 \_ 1 @ W 2 \_ 1 ) ,$$

$$transmit z 2 \_ 1 \_ 1 to Accelerator 1 \_ 2 ,$$

$$z 2 \_ 1 = z 2 \_ 1 \_ 1 + z 2 \_ 1 \_ 2 ,$$

are assigned to Accelerator 1_1 as the processing of the MLP block,

$$y2\_ 2 \_ 1 = f ( o 2 \_ 2 @ W 1 \_ 1 , z 2 \_ 2 \_ 1 = o 2 \_ 2 + ( y2\_ 2 \_ 1 @ W 2 \_ 1 ) , \\ transmit z 2 \_ 2 \_ 1 to Accelerator 2 \_ 2 , z2\_ 2 = z2\_ 2 \_ 1 + z2\_ 2 \_ 2 ,$$

are assigned to Accelerator 2_1 as the processing of the MLP block,

$$y2\_ 1 \_ 2 = f ( o 2 \_ 1 @ W 1 \_ 2 ) , z 2 \_ 1 \_ 2 = o 2 \_ 1 + ( y2\_ 1 \_ 1 @ W 2 \_ 2 ) , \\ transmit z 2 \_ 1 \_ 2 to Accelerator 1 \_ 1 , z2\_ 1 = z2\_ 1 \_ 1 + z2\_ 1 \_ 2 ,$$

are assigned to Accelerator 1_2 as the processing of the MLP block, and

$$y 2 \_ 2 \_ 2 = f ( o 2 \_ 2 @ W 1 \_ 2 ,$$

$$z 2 \_ 2 \_ 2 = o 2 \_ 2 + ( y 2 \_ 2 \_ 2 @ W 2 \_ 2 ) ,$$

$$transmit z 2 \_ 2 \_ 2 to Accelerator 2 \_ 1.$$

$$z 2 \_ 2 = z 2 \_ 2 \_ 1 + z 2 \_ 2 \_ 2.$$

are assigned to Accelerator 2_2 as the processing of the MLP block. Here, z2_1 and z2_2 are (L/2)×C matrices.

By assigning the processing in such a way, according to the scheduling unit 302, for example,
a process of communicating, between the Accelerator 1_1 and Accelerator 1_2, z1_1_1 and z1_1_2 calculated by using data based on the previous micro-batch as input data, and
a process of calculating y2_1_1 and z2_1_1 or a process of calculating y2_1_2 and z2_1_2, using data based on the next micro-batch as input data,
   can be performed in parallel. Additionally, according to the scheduling unit 302, for example,
a process of communicating, between Accelerator 2_1 and Accelerator 2_2, z1_2_1 and z1_2_2 calculated by using data based on the previous micro-batch as input data, and
a process of calculating y2_2_1 and z2_2_1 or a process of calculating y2_2_2 and z2_2_2, using data based on the next micro-batch as input data,
   can be performed in parallel.

### Summary

As is clear from the above description, in the information processing device 120 according to the fourth embodiment, in the scheduling when a training process is performed using tensor parallelism and sequence parallelism in the decoder of the Transformer,
the processing is assigned to a plurality of accelerators used for tensor parallelism and sequence parallelism so as to execute, in parallel, using the data based on two micro-batches adjacent in the processing order as a single set of input data, the communication processing, between the accelerators, of a result of executing the computational processing for the first input data in the attention block and the computational processing for the second input data in the attention block, and
the processing is assigned to a plurality of accelerators used for tensor parallelism and sequence parallelism so as to execute, in parallel, using the data based on two micro-batches adjacent in the processing order as a single set of input data, the communication processing, between the accelerators, of a result of executing the computational processing for the second input data in the attention block and the computational processing for the first input data in the MLP block, and
the processing is assigned to a plurality of accelerators used for tensor parallelism and sequence parallelism so as to perform, in parallel, using the data based on two micro-batches adjacent in the processing order as a single set of input data, the communication processing, between accelerators, of a result of executing the computational processing for the first input data in the MLP block and the computational processing for the second input data in the MLP block.

Additionally, when the server device according to the fourth embodiment performs the training process using the tensor parallelism and sequence parallelism in the decoder of the Transformer, the device is configured to:
execute, in parallel, using the data based on two micro-batches adjacent in the processing order as a set of input data, the communication processing, between accelerators, of a result of the computational processing for the first input data in the attention block and the computational processing for the second input data in the attention block;
execute, in parallel, using the data based on two micro-batches adjacent in the processing order as a set of input data, the communication processing, between accelerators, of a result of executing the computational processing for the second input data in the attention block and the computational processing for the first input data in the MLP block; an
execute, in parallel, using the data based on two micro-batches adjacent in the processing order as a set of input data, the communication processing, between accelerators, of a result of executing the computational processing for the first input data in the MLP block and the computational processing for the second input data in the MLP block.

With this, according to the fourth embodiment, the execution speed when the training process is performed using tensor parallelism and sequence parallelism can be improved.

Here, in the present embodiment, the case where the training process is performed using tensor parallelism and sequence parallelism, using data based on a plurality of micro-batches as input data in the decoder of the Transformer has been described. However, if the Transformer includes an encoder, the training process using tensor parallelism and sequence parallelism may be performed by substantially the same method in the encoder.

### Fifth Embodiment

In the embodiments described above, the specific examples of the forward calculation have been mainly described, but specific examples of backward data calculation and backward weight calculation are also substantially the same. However, in the case where there is no recalculation in the backward weight calculation, for example, when

$$gW 1 \_ 1 = gy 1 \_ 1. transpose @ x 1 \_ 1 ,$$

$$gW 1 \_ 2 = gy 1 \_ 2. transpose @ x 1 \_ 2 ,$$

are assigned to Accelerator 1, and

$$gW 2 \_ 1 = gy 2 \_ 1. transpose @ x 2 \_ 1 ,$$

$$gW 2 \_ 2 = gy 2 \_ 2. transpose @ x 2 \_ 2 ,$$

are assigned to Accelerator 2, no communication occurs. Here, x1_1 and x1_2 represent tensors for the first and second parameters in Accelerator 1, and x2_1 and x2_2 represent tensors for the first and second parameters in Accelerator 2. Additionally, gW represents the gradient of the weight, gy represents the gradient of the output, and x represents the input data.

Here, when the training process is performed using tensor parallelism, either gy or x is required to be held with being overlapped across accelerators. For example, in a matrix product close to the input of the MLP block, x is required to be held with being overlapped across accelerators used for tensor parallelism.

In this case, in order to avoid holding tensors for a long time, it is conceivable to perform scheduling such that tensors are distributed and held, and generated by calculation when needed.

In such a case, the backward weight calculation includes communication processing of collecting tensors and computational processing of calculating gradients, such as

$$x 1 = Allgather ( x 1 \_ 1 ) ,$$

and
gW1_1=gy1_1.transpose@x1. Thus, similarly to the embodiments described above, by using the data based on two micro-batches adjacent in the processing order as input data,
the processing can be assigned to a plurality of accelerators used for tensor parallelism so as to execute, in parallel, the communication processing using the data based on Micro-batch 2 as the input data and the computational processing using the data based on Micro-batch 1 as the input data, and
the processing can be assigned to a plurality of accelerators used for tensor parallelism so as to execute, in parallel, the communication processing using the data based on Micro-batch 1 as the input data and the computational processing using the data based on Micro-batch 2 as the input data.

As a result, the execution speed when the training process is performed using tensor parallelism can be improved.

### Sixth Embodiment

In the embodiments described above, as examples of the intra-layer parallelism, tensor parallelism and sequence parallelism have been described, but as other parallelisms, for example, expert parallelism in Mixture of Expert (MoE) may be used. A system of expert parallelism is configured to switch a deep neural network (DNN) to be used for each input token. Therefore, the execution speed can be improved by performing scheduling so as to perform the transmission of the token to the switching destination and the processing of the token at the switching destination in parallel.

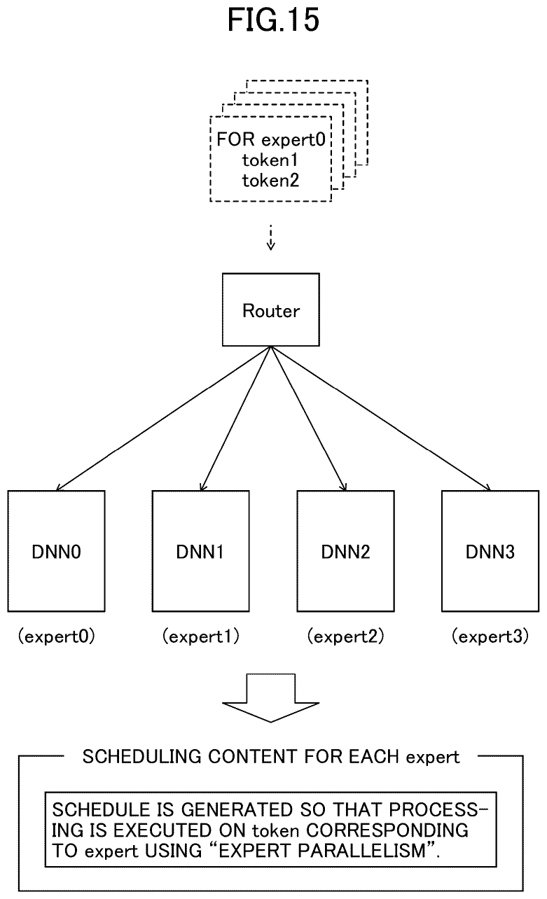

FIG. 15 is a diagram illustrating an outline of scheduling by an information processing device according to a sixth embodiment, and each DNN, which is a model to be trained, is trained using expert parallelism. The example of FIG. 15 indicates that a token for expert0 is transmitted to DNN0 and used for training DNN0, and a token for expert1 is transmitted to DNN1 and used for training DNN1. Additionally, the example of FIG. 15 indicates that a token for expert2 is transmitted to DNN2 and used for training DNN2, and a token for expert3 is transmitted to DNN3 and used for training DNN3.

As described, in the case of expert parallelism, transmission processing of the tokens corresponding to the experts and computational processing of the experts are executed. Therefore, by scheduling, as a group, two tokens corresponding to the same expert in a continuous processing order,
the transmission processing of the token, and
the computational processing of the expert can be executed in parallel.

Here, although a hardware configuration is not mentioned in the above description, Router that transmits the token and the DNN that performs the computational processing of each expert may be implemented in the same worker or in different workers.

Additionally, DNN0 to DNN3 may be implemented in the same worker or in different workers. When DNN0 to DNN3 are implemented in different workers, for example, DNN0 and DNN1 may be implemented in the worker whose worker name is “Worker0”, and DNN2 and DNN3 may be implemented in the worker whose worker name is “Worker1”.

### Seventh Embodiment

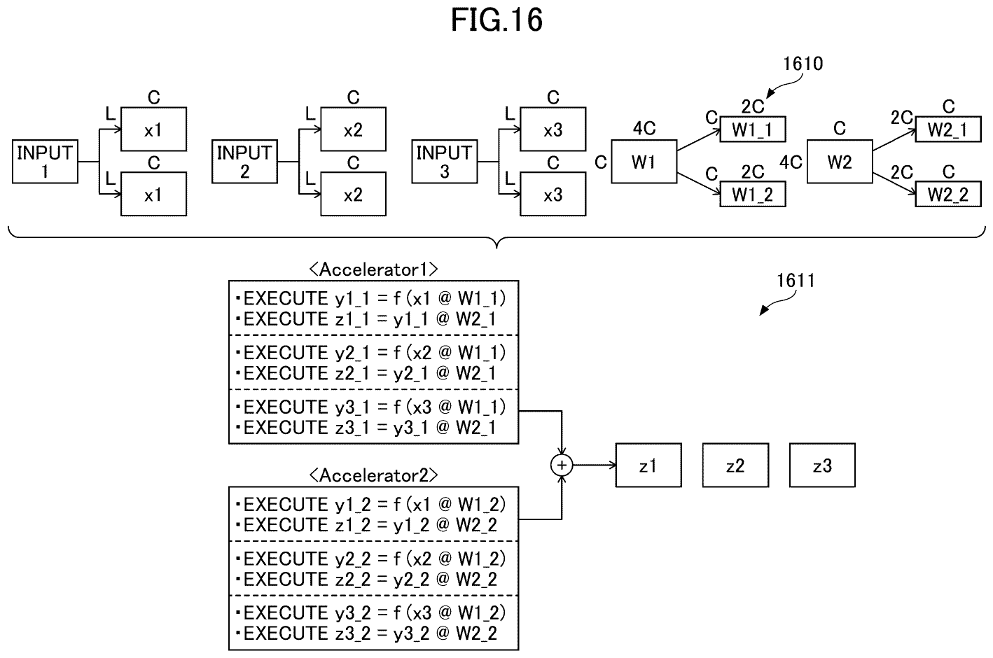

In the first embodiment described above, the case where the scheduling unit 302 schedules, as a group, the processing for the data based on two micro-batches has been described. However, a target object handled by the processing to be scheduled as a group is not limited to the data based on two micro-batches. Processing for any other suitable input data may be scheduled as a group. FIG. 16 is a diagram illustrating a specific example of scheduling by a scheduling unit of an information processing device according to a seventh embodiment. The difference from FIG. 6 described in the first embodiment is that in FIG. 6, data x1 and the like are data based on the micro-batches, but in FIG. 16, data x1 and the like are any input data other than the data based on the micro-batches. Additionally, the difference from FIG. 6 is that in FIG. 6, processing scheduling for data x1 and x2 is illustrated, but in FIG. 16, processing scheduling for data x1 to x3 is illustrated.

As indicated by reference numeral 1610, in order to enable tensor parallelism, the scheduling unit 302 generates the input data x1 to x3 (L×C matrix) in accordance with the number of accelerators (here, the number of generated data=2).

Additionally, as indicated by reference numeral 1610, in order to enable tensor parallelism, the scheduling unit 302 partitions the weight parameters W1 (C×4C matrix) and W2 (4C×C matrix) in accordance with the number of accelerators (in this case, the number of partitions=2). With this, W1_1 and W1_2 (C×2C matrix), and W2_1 and W2_2 (2C×C matrix) after the partitioning to be assigned to the respective accelerators can be generated.

Subsequently, as indicated by reference numeral 1611, the scheduling unit 302 assigns the processing in Accelerators 1 and 2. The example of reference numeral 1611 indicates a state in which

$$y 1 \_ 1 = f ( x 1 @ W 1 \_ 1 ) and$$

$$z 1 \_ 1 = y 1 \_ 1 @ W 2 \_ 1 ,$$

are assigned to Accelerator 1, and

$$y 1 \_ 2 = f ( x 1 @ W 1 \_ 2 ) and$$

$$z 1 \_ 2 = y 1 \_ 2 @ W 2 \_ 2 ,$$

are assigned to Accelerator 2. Here, y1_1 and y1_2 are L×2C matrices, and z1_1 and z1_2 are L×C matrices.

Additionally, the example of reference numeral 1611 indicates how z1 (L×C matrix) is calculated by summing z1_1 (L×C matrix) and z1_2 (L×C matrix), calculated by processing in Accelerators 1 and 2. For example, when z1_1 (L×C matrix) and z1_2 (L×C matrix) are summed in Accelerators 1 and 2, z1_1 (L×C matrix) is transmitted from Accelerator 1 to Accelerator 2. Additionally, z1_2 (L×C matrix) is transmitted from Accelerator 2 to Accelerator 1. That is, communication processing occurs between accelerators.

Here, the scheduling unit 302 performs scheduling so that each accelerator executes computational processing for the next input data in parallel while communication processing is executed between accelerators.

The example of reference numeral 1611 indicates a state in which, while communication processing is being executed between accelerators,

$$y 2 \_ 1 = f ( x 2 @ W 1 \_ 1 ) , and$$

$$z 2 \_ 1 = y 2 \_ 1 @ W 2 \_ 1 ,$$

are assigned to Accelerator 1, and

$$y 2 \_ 2 = f ( x 2 @ W 1 \_ 2 ) , and$$

$$z 2 \_ 2 = y 2 \_ 2 @ W 2 \_ 2 ,$$

are assigned to Accelerator 2. Here, y2_1 and y2_2 are L×2C matrices, and z2_1 and z2_2 are L×C matrices.

Additionally, the example of reference numeral 1611 indicates how z2 (L×C matrix) is calculated by summing z2_1 (L×C matrix) and z2_2 (L×C matrix), calculated by processing in Accelerators 1 and 2. For example, when z2_1 (L×C matrix) and z2_2 (L×C matrix) are summed in Accelerators 1 and 2, z2_1 (L×C matrix) is transmitted from Accelerator 1 to Accelerator 2. Additionally, z2_2 (L×C matrix) is transmitted from Accelerator 2 to Accelerator 1. That is, communication processing occurs between accelerators.

Here, the scheduling unit 302 performs scheduling so that each accelerator executes processing for the next input data in parallel while communication processing is executed between accelerators.

The example of reference numeral 1611 indicates a state in which, while communication processing is executed between accelerators,

$$y 3 \_ 1 = f ( x 3 @ W 1 \_ 1 ) and$$

$$z 3 \_ 1 = y 3 \_ 1 @ W 2 \_ 1 ,$$

are assigned to Accelerator 1, and

$$y 3 \_ 2 = f ( x 3 @ W 1 \_ 2 ) and$$

$$z 3 \_ 2 = y 3 \_ 1 @ W 2 \_ 2 ,$$

are assigned to Accelerator 2. Here, y3_1 and y3_2 are L×2C matrices, and z3_1 and z3_2 are L×C matrices.

As described, the scheduling unit 302 schedules the processing for two input data adjacent in the processing order as a group to enable the computational processing below:

$$y = f ( x @ W 1 )$$

$$z = y @ W 2$$

and the communication processing between accelerators to be executed in parallel. As a result, according to the scheduling unit 302, the execution speed when the training process is performed using tensor parallelism can be improved.

### OTHER EMBODIMENTS

In the fourth embodiment described above, the case where the model on which the training process is performed using sequence parallelism is a Transformer has been described. However, the model on which the training process is performed using sequence parallelism is not limited to a Transformer and may be a NN.

Additionally, in the embodiments described above, a micro-batch has been described as an example of a processing unit (batch) of training data for the execution of each worker during the training process. However, the batch of training data is not limited to a micro-batch and may be a mini-batch. Additionally, a single batch may be one of multiple pieces of data in which the training data is partitioned or may include one or more pieces of data included in the training data.

Additionally, in the fifth embodiment described above, the description assumes that when each worker executes the backward calculation, the backward data calculation and the backward weight calculation are separated and executed. However, in the scheduling of some workers (for example, a worker with worker name=“Worker0”), the backward data calculation and the backward weight calculation may be scheduled as a group without being separated.

Additionally, in the embodiments described above, the case where the information processing device 120 applies the scheduling method to the training process has been described, but the information processing device 120 may apply the scheduling method to a process other than the training process. That is, the information processing device 120 may apply the scheduling method to data based on data other than the training data.

Additionally, in the embodiments described above, when the training process is performed, the data based on two micro-batches are grouped together, and the communication processing between accelerators after the computational processing for the first input data and the computational processing for the second input data are performed in parallel. However, the execution method is not limited to performing a training process, and may be applied to performing an inference process. For example, when a plurality of sets of input data are input in the inference process,
communication processing between accelerators after computational processing for the first input data in an accelerator, and
computational processing for the second input data in the accelerator in the inference process may be executed in parallel. Thus, the execution speed when the inference process is performed can be improved.

As described, the parallel processing described in the above embodiments (tensor parallelism, sequence parallelism, expert parallelism, or any combination of the three) is not limited to a training process but may be applied to an inference processing. Additionally, the parallel processing herein includes intra-layer parallelism, and the intra-layer parallelism refers to processing in which calculation of one layer is calculated by a plurality of workers.

Additionally, in the embodiments described above, the examples of executing the communication processing and the computational processing in parallel are provided, but which communication processing and which computational processing are executed in parallel are suitably determined and are not limited to the examples provided in the embodiments described above.

Additionally, in the embodiments described above, the model used for the training process or the inference processing may be a machine learning model. The machine learning model herein may be, for example, a generative model, a base model, or a neural network configured to generate various data such as a voice, an image, and a moving image. Additionally, the machine learning model may be multi-modal.

Additionally, in the embodiments described above, the data based on two micro-batches are grouped together, one data is defined as the first input data, and the other data is defined as the second input data, but the definitions of the first input data and the second input data are not limited thereto. For example, the first input data and the second input data may be data used for a model training process or an inference process. Additionally, the units, separations, and the like of the first input data and the second input data may be suitably determined as long as they do not conflict with the context. Additionally, the first input data and the second input data may be respectively obtained by partitioning the other first input data and the other second input data. Additionally, the first input data and the second input data may be separate input data. Additionally, the first input data and the second input data may be independently calculated. Additionally, the first input data and the second input data may be data that can be input into a model. When the model is a large-scale language model, as a non-limiting example, the first input data and the second input data may be text data.

Additionally, although the weight parameter among the model parameters is mentioned in the embodiments described above, the model parameters used for parallel processing may include bias and other normalization parameters in addition to the weight parameter. Here, when the model parameters are partitioned in parallel processing, the model parameters may be partitioned equally or not equally.

Additionally, in the embodiments described above, the case where the information processing device 120 is provided separately from the server device group 110 has been described. However, the information processing device 120 may be integrated with the server device group 110.

Specifically, all the functions of the information processing device 120 may be implemented in some servers of the server device group 110. That is, the information processing system 100 may include the server device group 110 including N servers, one information processing device 120, or may include the server device group 110 including (N−1) servers, and one server device. Alternatively, the information processing device 120 itself may be a worker or a part of a worker. Alternatively, the information processing system 100 may include a plurality of server devices (the server device group 110) or an information processing device including a plurality of processors.

Additionally, in the embodiments described above, although the description assumes that there is one information processing device 120 in the information processing system 100, the information processing device 120 may include a plurality of devices.

In the present specification (including the claims), if the expression “at least one of a, b, and c” or “at least one of a, b, or c” is used (including similar expressions), any one of a, b, c, a-b, a-c, b-c, or a-b-c is included. Multiple instances may also be included in any of the elements, such as a-a, a-b-b, and a-a-b-b-c-c. Further, the addition of another element other than the listed elements (i.e., a, b, and c), such as adding d as a-b-c-d, is included.

In the present specification (including the claims), if the expression such as “in response to data being input”, “based on data”, “according to data”, or “in accordance with data” (including similar expressions) is used, unless otherwise noted, a case in which various data itself is used as an input and a case in which data obtained by processing various data (e.g., data obtained by adding noise, normalized data, and intermediate representation of various data) is used as an input are included. If it is described that any result can be obtained “based on data”, “according to data”, or “in accordance with data”, a case in which the result is obtained based on only the data is included, and a case in which the result is obtained affected by another data other than the data, factors, conditions, and/or states may be included. If it is described that “data is output”, unless otherwise noted, a case in which various data itself is used as an output is included, and a case in which data obtained by processing the data in some way (e.g., data obtained by adding noise, normalized data, and intermediate representation of the data) is used as an output is included.

In the present specification (including the claims), if the terms “connected” and “coupled” are used, the terms are intended as non-limiting terms that include any of direct, indirect, electrically, communicatively, operatively, and physically connected/coupled. Such terms should be interpreted according to a context in which the terms are used, but a connected/coupled form that is not intentionally or naturally excluded should be interpreted as being included in the terms without being limited.

In the present specification (including the claims), if the expression “A configured to B” is used, a case in which a physical structure of the element A has a configuration that can perform the operation B, and a permanent or temporary setting/configuration of the element A is configured/set to actually perform the operation B may be included. For example, if the element A is a general purpose processor, the processor may have a hardware configuration that can perform the operation B and be configured to actually perform the operation B by setting a permanent or temporary program (i.e., an instruction). If the element A is a dedicated processor, a dedicated arithmetic circuit, or the like, a circuit structure of the processor may be implemented so as to actually perform the operation B irrespective of whether the control instruction and the data are actually attached.

In the present specification (including the claims), if a term indicating inclusion or possession (e.g., “comprising”, “including”, or “having”) is used, the term is intended as an open-ended term, including inclusion or possession of an object other than a target object indicated by the object of the term. If the object of the term indicating inclusion or possession is an expression that does not specify a quantity or that suggests a singular number (i.e., an expression using “a” or “an” as an article), the expression should be interpreted as being not limited to a specified number.

In the present specification (including the claims), even if an expression such as “one or more” or “at least one” is used in a certain description, and an expression that does not specify a quantity or that suggests a singular number (i.e., an expression using “a” or “an” as an article) is used in another description, it is not intended that the latter expression indicates “one”. Generally, an expression that does not specify a quantity or that suggests a singular number (i.e., an expression using “a” or “an” as an article) should be interpreted as being not necessarily limited to a particular number.

In the present specification, if it is described that a particular advantage/result is obtained in a particular configuration included in an embodiment, unless there is a particular reason, it should be understood that that the advantage/result may be obtained in another embodiment or other embodiments including the configuration. It should be understood, however, that the presence or absence of the advantage/result generally depends on various factors, conditions, states, and/or the like, and that the advantage/result is not necessarily obtained by the configuration. advantage/result is merely an advantage/result that is obtained by the configuration described in the embodiment when various factors, conditions, and/or states are satisfied, and is not necessarily obtained in the invention according to the claim that defines the configuration or a similar configuration.

In the present specification (including the claims), if multiple hardware performs predetermined processes, each of the hardware may cooperate to perform the predetermined processes, or some of the hardware may perform all of the predetermined processes. Additionally, some of the hardware may perform some of the predetermined processes while other hardware may perform the remainder of the predetermined processes. In the present specification (including the claims), if an expression such as “one or more hardware perform a first process and the one or more hardware perform a second process” is used, the hardware that performs the first process may be the same as or different from the hardware that performs the second process. That is, the hardware that performs the first process and the hardware that performs the second process may be included in the one or more hardware. The hardware may include an electronic circuit, a device including an electronic circuit, or the like.

In the present specification (including the claims), if multiple storage devices (memories) store data, each of the multiple storage devices (memories) may store only a portion of the data or may store an entirety of the data.

Although the embodiments of the present disclosure have been described in detail above, the present disclosure is not limited to the individual embodiments described above. Various additions, modifications, substitutions, partial deletions, and the like can be made without departing from the conceptual idea and spirit of the invention derived from the contents defined in the claims and the equivalents thereof. For example, in all the embodiments described above, the numerical values used in the description are described as examples and the embodiments are not limited thereto. Additionally, the order of the operations in the embodiments is described as an example and the embodiments are not limited thereto.

Here, in the disclosed technique, the following appended forms can be considered.

(Clause 1) An information processing system includes a plurality of memories and a plurality of processors configured to perform parallel processing using a model,
wherein the plurality of processors execute communication processing of a result of executing computational processing using at least a part of the model for first input data, and computational processing using at least a part of the model for second input data, such that processing periods of the communication processing and the computational processing at least partially overlap.

(Clause 2) The information processing system as described in Clause 1, wherein the parallel processing is processing using intra-layer parallelism.

(Clause 3) The information processing system as described in Clause 1 or Clause 2, wherein the first input data and the second input data are data based on two micro-batches adjacent in a processing order in a training process of the model.

(Clause 4) The information processing system as described in Clause 1 or Clause 2, wherein the first input data and the second input data are data used in an inference process using the model.

(Clause 5) The information processing system as described in any one of Clause 1 to Clause 4,
wherein the parallel processing is performed by using at least tensor parallelism,
wherein processors used for the tensor parallelism each execute computational processing using a partitioned model parameter and at least one of the first input data or the second input data;
wherein the partitioned model parameter is obtained by partitioning model parameters of the model based on a number of the processors used for the tensor parallelism.

(Clause 6) The information processing system as described in Clause 5,
wherein a first processor executes computational processing using a first model parameter after the partitioning and the first input data,
wherein a second processor executes computational processing using a second model parameter after the partitioning and the first input data,
wherein communication processing of sending and receiving a result of the first processor executing the computational processing and a result of the second processor executing the computational processing between the first processor and the second processor is executed,
wherein the first processor executes computational processing using the first model parameter and the second input data such that a processing period of the computational processing and a processing period of the communication processing at least partially overlap; and
wherein the second processor executes computational processing using the second model parameter and the second input data such that a processing period of the computational processing and a processing period of the communication processing at least partially overlap.

(Clause 7) The information processing system as described in any one of Clause 1 to Clause 4,
wherein the parallel processing is performed by using at least sequence parallelism,
wherein the first input data and the second input data are partitioned based on a number of processors used for the sequence parallelism, and
wherein the processors used for the sequence parallelism each execute computational processing using at least one of the partitioned first input data or the partitioned second input data and a model parameter of the model.

(Clause 8) The information processing system as described in Clause 7,
wherein a first processor executes computational processing using one of the partitioned first input data and the model parameter,
wherein a second processor executes computational processing using another one of the partitioned first input data and the model parameter,
wherein communication processing of sending and receiving a result of the first processor executing the computational processing and a result of the second processor executing the computational processing between the first processor and the second processor is executed,
wherein the first processor executes computational processing using one of the partitioned second input data and the model parameter such that a processing period of the computational processing and a processing period of the communication processing at least partially overlap, and
wherein the second processor executes computational processing using another one of the partitioned second input data and the model parameter such that a processing period of the computational processing and a processing period of the communication processing at least partially overlap.

(Clause 9) The information processing system as described in Clause 1,
wherein the parallel processing is performed by using a combination of tensor parallelism and sequence parallelism,
wherein the first input data and the second input data are partitioned based on a number of processors used for the combination of the tensor parallelism and the sequence parallelism,
wherein the processors each execute computational processing using a partitioned model parameter and at least one of the partitioned first input data or the partitioned second input data, and
wherein the partitioned model parameter is obtained by partitioning model parameters of the model based on a number of the processors used for the combination of the tensor parallelism and the sequence parallelism.

(Clause 10) The information processing system as claimed in any one of Clause 1 to Clause 9,
wherein the model is a neural network, and
wherein the computational processing and the communication processing are computational processing and communication processing in the neural network.

(Clause 11) The information processing system as described in Clause 10,
wherein the neural network includes a Transformer, and
wherein the computational processing and the communication processing include at least computational processing and communication processing in one of an attention block of an encoder included in the Transformer, a multi-layer perceptron (MLP) block of the encoder, or an MLP block of a decoder included in the Transformer.

(Clause 12) An information processing system comprising: a plurality of memories and a plurality of processors configured to perform expert parallel processing using a plurality of experts,
wherein the plurality of processors execute transmission processing of transmitting, to an expert, a token corresponding to the expert, and computational processing for the token in the exert, such that processing periods of the transmission processing and the computational processing at least partially overlap.

(Clause 13) An information processing device comprising a plurality of memories and a plurality of processors configured to perform scheduling to perform parallel processing using a model,
wherein the plurality of processors perform the scheduling to execute communication processing of a result of executing computational processing using at least a part of the model for first input data and computational processing using at least a part of the model for second input data, such that processing periods of the communication processing and the computational processing at least partially overlap.

(Clause 14) An information processing method comprising executing, by a plurality of processors of an information processing device configured to perform parallel processing using a model, communication processing of a result of executing computational processing using at least a part of the model for first input data and computational processing using at least a part of the model for second input data, such that processing periods of the communication processing and the computational processing at least partially overlap.

(Clause 15) A scheduling method comprising performing, by a plurality of processors of an information processing device configured to perform scheduling to perform parallel processing using a model, the scheduling to execute communication processing of a result of executing computational processing using at least a part of the model for first input data and computational processing using at least a part of the model for second input data, such that processing periods of the communication processing and the computational processing at least partially overlap.

(Clause 16) An information processing program for causing a processor of an information processing device configured to perform parallel processing using a model to execute communication processing of a result of executing computational processing using at least a part of the model for first input data and computational processing using at least a part of the model for second input data, such that processing periods of the communication processing and the computational processing at least partially overlap.

(Clause 17) A scheduling program for causing a processor of an information processing device configured to perform scheduling to perform parallel processing using a model to perform the scheduling to execute communication processing of a result of executing computational processing using at least a part of the model for first input data and computational processing using at least a part of the model for second input data, such that processing periods of the communication processing and the computational processing at least partially overlap.

What is claimed is:

1. An information processing system comprising a plurality of memories and a plurality of processors configured to perform parallel processing using a model,
wherein the plurality of processors execute communication processing of a result of executing computational processing using at least a part of the model for first input data, and computational processing using at least a part of the model for second input data, such that processing periods of the communication processing and the computational processing at least partially overlap.

2. The information processing system as claimed in claim 1, wherein the parallel processing is processing using intra-layer parallelism.

3. The information processing system as claimed in claim 1, wherein the first input data and the second input data are data based on two micro-batches adjacent in a processing order in a training process of the model.

4. The information processing system as claimed in claim 1, wherein the first input data and the second input data are data used in an inference process using the model.

5. The information processing system as claimed in claim 1,
wherein the parallel processing is performed by using at least tensor parallelism,
wherein processors used for the tensor parallelism each execute computational processing using a partitioned model parameter and at least one of the first input data or the second input data;
wherein the partitioned model parameter is obtained by partitioning model parameters of the model based on a number of the processors used for the tensor parallelism.

6. The information processing system as claimed in claim 5,
wherein a first processor executes computational processing using a first model parameter after the partitioning and the first input data,
wherein a second processor executes computational processing using a second model parameter after the partitioning and the first input data,
wherein communication processing of sending and receiving a result of the first processor executing the computational processing and a result of the second processor executing the computational processing between the first processor and the second processor is executed,
wherein the first processor executes computational processing using the first model parameter and the second input data such that a processing period of the computational processing and a processing period of the communication processing at least partially overlap; and
wherein the second processor executes computational processing using the second model parameter and the second input data such that a processing period of the computational processing and a processing period of the communication processing at least partially overlap.

7. The information processing system as claimed in claim 1,
wherein the parallel processing is performed by using at least sequence parallelism,
wherein the first input data and the second input data are partitioned based on a number of processors used for the sequence parallelism, and
wherein the processors used for the sequence parallelism each execute computational processing using at least one of the partitioned first input data or the partitioned second input data and a model parameter of the model.

8. The information processing system as claimed in claim 7,
wherein a first processor executes computational processing using one of the partitioned first input data and the model parameter,
wherein a second processor executes computational processing using another one of the partitioned first input data and the model parameter,
wherein communication processing of sending and receiving a result of the first processor executing the computational processing and a result of the second processor executing the computational processing between the first processor and the second processor is executed,
wherein the first processor executes computational processing using one of the partitioned second input data and the model parameter such that a processing period of the computational processing and a processing period of the communication processing at least partially overlap, and
wherein the second processor executes computational processing using another one of the partitioned second input data and the model parameter such that a processing period of the computational processing and a processing period of the communication processing at least partially overlap.

9. The information processing system as claimed in claim 1,
wherein the parallel processing is performed by using a combination of tensor parallelism and sequence parallelism,
wherein the first input data and the second input data are partitioned based on a number of processors used for the combination of the tensor parallelism and the sequence parallelism,
wherein the processors each execute computational processing using a partitioned model parameter and at least one of the partitioned first input data or the partitioned second input data, and
wherein the partitioned model parameter is obtained by partitioning model parameters of the model based on a number of the processors used for the combination of the tensor parallelism and the sequence parallelism.

10. The information processing system as claimed in claim 1,
wherein the model is a neural network, and
wherein the computational processing and the communication processing are computational processing and communication processing in the neural network.

11. The information processing system as claimed in claim 10,
wherein the neural network includes a Transformer, and
wherein the computational processing and the communication processing include at least computational processing and communication processing in one of an attention block of an encoder included in the Transformer, a multi-layer perceptron (MLP) block of the encoder, or an MLP block of a decoder included in the Transformer.

12. An information processing system comprising: a plurality of memories and a plurality of processors configured to perform expert parallel processing using a plurality of experts,
wherein the plurality of processors execute transmission processing of transmitting, to an expert, a token corresponding to the expert, and computational processing for the token in the expert, such that processing periods of the transmission processing and the computational processing at least partially overlap.

13. An information processing method comprising executing, by a plurality of processors of an information processing device configured to perform parallel processing using a model, communication processing of a result of executing computational processing using at least a part of the model for first input data and computational processing using at least a part of the model for second input data, such that processing periods of the communication processing and the computational processing at least partially overlap.

14. The information processing method as claimed in claim 13, wherein the parallel processing is processing using intra-layer parallelism.

15. The information processing method as claimed in claim 13, wherein the first input data and the second input data are data based on two micro-batches adjacent in a processing order in a training process of the model.

16. The information processing method as claimed in claim 13, wherein the first input data and the second input data are data used in an inference process using the model.

17. The information processing method as claimed in claim 13,
wherein the parallel processing is performed by using at least tensor parallelism,
wherein processors used for the tensor parallelism each execute computational processing using a partitioned model parameter and at least one of the first input data or the second input data;
wherein the partitioned model parameter is obtained by partitioning model parameters of the model based on a number of the processors used for the tensor parallelism.

18. The information processing method as claimed in claim 13,
wherein the parallel processing is performed by using at least sequence parallelism,
wherein the first input data and the second input data are partitioned based on a number of processors used for the sequence parallelism, and
wherein the processors used for the sequence parallelism each execute computational processing using at least one of the partitioned first input data or the partitioned second input data and a model parameter of the model.

19. The information processing method as claimed in claim 13,
wherein the parallel processing is performed by using a combination of tensor parallelism and sequence parallelism,
wherein the first input data and the second input data are partitioned based on a number of processors used for the combination of the tensor parallelism and the sequence parallelism,
wherein the processors each execute computational processing using a partitioned model parameter and at least one of the partitioned first input data or the partitioned second input data, and
wherein the partitioned model parameter is obtained by partitioning model parameters of the model based on a number of the processors used for the combination of the tensor parallelism and the sequence parallelism.

20. The information processing method as claimed in claim 13,
wherein the model is a neural network, and
wherein the computational processing and the communication processing are computational processing and communication processing in the neural network.
